(19) United States
(12) Patent Application Publication
(10) Pub. No.: US 2026/0266357 A1
(43) Pub. Date: Sep. 10, 2026

(54) DRIVE DEVICE, TRANSMISSION HOUSING ASSEMBLY AND WORKING MACHINE

(71) Applicant: DEERE & COMPANY, MOLINE, IL (US)

(72) Inventor: Manuel Mann, Hüffenhardt (DE)

(21) Appl. No.: 19/400,311

(22) Filed: Nov. 25, 2025

(30) Foreign Application Priority Data
Mar. 10, 2025 (EP) 25162498.7

(51) Int. Cl. F16H 3/00; F16H 3/72

(52) U.S. Cl. CPC F16H 3/006; F16H 3/725

(57) ABSTRACT

The present disclosure relates to a drive device for a working machine or a transmission housing assembly. The drive device comprises a drive, a drive output, a first and a second variators and a first transmission unit which is configured as a planetary coupling transmission with a first and a second input sides and a first and a second output sides. The first variator is connectable to the drive, and the second variator is connected to the second input side. The drive device comprises a second transmission unit with a third and a fourth input sides and at least one third output side. The first output side is connectable to the third input side or the second output side is connectable to the fourth input side. The third output side of the second transmission unit is connectable to the drive output.

### CROSS-REFERENCE TO RELATED APPLICATIONS

This application claims priority to European Patent Application No 25162498.7, filed Mar. 10, 2025, which is hereby incorporated by reference.

### TECHNICAL FIELD

The present disclosure relates generally to a drive device, a transmission and a working machine.

### BACKGROUND

For a long time, drive devices have been used in working machines, in particular agricultural towing vehicles, in order to be able to vary the propulsion of the working machine without interruption, even under a high towing load, for example caused by an implement such as a tilling apparatus (e.g. plough) or the like, attached thereto, beyond simply varying the rotating speed of the drive motor. In this context, the drive device can in particular be a transmission able to be shifted under load. It is a known measure to increase the number of gear stages of a drive device in such a way that the latter comprises a combination of transmissions. DE 10 2013 110 709 A1 discloses such a drive device. The transmissions used in that document may in turn be known as dual-clutch transmissions from WO 2009/050078 A2. It is furthermore known from DE 10 2013 110 709 A1 that the number of available transmission ratios can be increased with such a drive device. A disadvantage of the known drive devices is that the required installation space is excessive. Likewise, the drive device lacks modularity, the latter making it possible to adapt the drive device to the respective working machine.

### SUMMARY

It is an object of the present disclosure to propose a drive device, a transmission housing assembly and a working machine that are improved. Specifically, it can be an object of the present disclosure to propose a drive device and/or a transmission housing assembly and/or a working machine that are of a simpler construction and/or of a more compact and/or more modular design.

This object is achieved by a drive device with the features of one or more embodiments disclosed herein, a transmission housing assembly having the features of one or more embodiments disclosed herein, and a working machine having the features of one or more embodiments disclosed herein.

Proposed according to the disclosure is a drive device for a working machine or a transmission housing assembly.

The drive device comprises a drive, in particular a drive shaft, and a drive output, in particular a drive output shaft, and a first and a second variators, and a first transmission unit which is designed as a planetary coupling transmission with a first and a second input side and a first and a second output side. The first variator is connectable, or connected, to the drive and the second variator is connectable, or connected, to the second input side. The drive device furthermore comprises a second transmission unit with a third and a fourth input side and at least one third output side. The first output side is connectable, or connected, to the third input side and/or the second output side is connectable, or connected, to the fourth input side. The second transmission unit, in particular the third output side, is connectable, or connected, to the drive output.

The term connected is preferably understood to mean mechanically connected and/or mechanically operatively connected. Specifically, the term connected is additionally or alternatively understood to mean drivably connected, thus connected in a torque and/or rotating speed transmitting manner, and/or coupled, thus in particular mechanically coupled and/or rigidly coupled, and/or co-rotationally coupled. The term connectable is preferably understood to mean mechanically connectable, and/or mechanically operatively connectable. Specifically, the term connectable is additionally or alternatively understood to mean drivably connectable, thus connectable in a torque and/or rotating speed transmitting manner, and/or couplable, thus mechanically couplable and/or rigidly couplable, and/or co-rotationally connectable. The term connected is thus specifically understood to mean a connection between two components, which enables energy and/or force and/or torque and/or rotating speed to be transmitted from the one component to the other component, in particular by mechanical means. Further components or parts enabling such a transmission of energy and/or force and/or torque and/or transmission of a rotating speed between the two components can be provided between the two components.

A shifting element, in particular the first and/or the second and/or the third and/or the fourth and/or a fifth and/or a sixth and/or a seventh and/or an eighth and/or a ninth and/or a tenth shifting element, can be understood to be a connecting part by which at least one part that transmits energy and/or force and/or torque and/or rotating speed is connectable to, in a manner so as to effectively drive, a further part that transmits energy and/or force and/or torque and/or rotating speed, or a part that is fixed in position or in a housing. The respective shifting element is shiftable between at least an opened state and a closed state, wherein the shifting element in the closed state can transmit neither energy nor force nor torque nor rotating speed between two parts that interact with the shifting element, and wherein the shifting element in the closed state can transmit energy and/or force and/or torque and/or rotating speed between the two parts that interact with the shifting element. If there is a connection, in particular an operative connection, between two elements or components of the drive device, energy and/or force and/or torque and/or rotating speed are/is transmitted from one element or one component to the other element or the other component. A shifting element, in particular the first and/or the second and/or the third and/or the fourth and/or the fifth and/or the sixth and/or the seventh and/or the eighth and/or the ninth and/or the tenth shifting element, can be a clutch, in particular a multi-disc clutch, and/or a brake and/or a synchronizer and/or a dog clutch. Specifically, the first and/or the second and/or the third and/or the fourth and/or the fifth and/or the sixth and/or the seventh and/or the eighth and/or the ninth and/or the tenth shifting element can be designed as powershift clutches, preferably as multi-disc clutches (or as dry single-disc clutches), particularly preferably as friction clutches. However, the first and/or the second and/or the third and/or the fourth and/or the fifth and/or the sixth and/or the seventh and/or the eighth and/or the ninth and/or the tenth shifting element can also be designed as non-powershift clutches.

Hereunder, an input side, in particular the first and/or the second and/or the third and/or the fourth and/or a fifth and/or a sixth and/or a seventh and/or an eighth and/or a ninth and/or a tenth input side, can be a mechanical interface by way of which force and/or torque and/or rotating speed can be directed into the transmission units, preferably into the first and/or the second and/or a third and/or a fourth transmission unit. Hereunder, an output side, in particular the first and/or the second and/or the third and/or a fourth and/or a fifth and/or a sixth and/or a seventh and/or an eighth and/or a ninth and/or a tenth output side and/or the drive output and/or the layshaft, can be a mechanical interface by way of which force and/or torque and/or rotating speed can be directed out of the transmission units, preferably out of the first and/or the second transmission unit and/or a third and/or a fourth transmission unit.

The drive device, in particular the first input side, can comprise a first drive element or be designed as a first drive element. The drive device, in particular the second input side, can comprise a second drive element or be designed as a second drive element. The first and/or the second input side, in particular the first and/or the second drive element, can be designed as, and/or comprise, a shaft, in particular a first and/or a second input shaft, and/or a gearwheel and/or a shifting element, for example.

The drive device, in particular the first output side, can comprise a first drive output element or be designed as a first drive output element. The drive device, in particular the second output side, can comprise a second drive output element or be designed as a second drive output element. The drive device, preferably the first and/or the second output side, particularly preferably the first and/or the second drive output element, can be designed as, and/or comprise, a shaft, in particular a first and/or a second output shaft, and/or a gearwheel and/or a shifting element, for example.

The drive device, or in particular the working machine, can comprise a propulsion drive, in particular a front-axle drive and/or a rear-axle drive. The drive output can be connected to a propulsion drive, in particular the front-axle drive and/or the rear-axle drive. The propulsion drive can comprise a first vehicle axle or front axle, and/or a second vehicle axle or rear axle, and/or a first differential or a front-axle differential, and/or a second differential or a rear-axle differential, and/or the one or more ground-engaging means. The front-axle drive can comprise the first vehicle axle or front axle, and/or the first differential or the front-axle differential, and/or the one or more ground-engaging means. The rear-axle drive can comprise the second vehicle axle or rear axle, and/or the second differential or the rear-axle differential, and/or the one or more ground-engaging means. The first differential can on the drive side be connectable, or connected, to the drive output and/or a layshaft. Moreover, the first differential can on the drive output side be connectable, or connected, to the first vehicle axle, in particular to a left shaft and a right shaft for driving ground-engaging means. The second differential can on the drive side be connectable, or connected, to the drive output and/or the layshaft. Moreover, the second differential can on the drive output side be connectable, or connected, to the second vehicle axle, in particular to a left shaft and a right shaft for driving ground-engaging means. Specifically, a rear axle bevel gear can be connected, in particular co-rotationally connected, to the drive output, in particular the drive output shaft. A pinion of the rear axle bevel gear can be designed as part of the drive output, in particular of the drive output shaft, preferably be integrated in the drive output, in particular the drive output shaft. Expensive and maintenance-prone connecting elements, for example an articulated shaft, can advantageously be eliminated due to the direct connection between the drive output, in particular the drive output shaft, and the rear axle bevel gear.

The drive device and/or the working machine can comprise a control unit. The control unit can be configured to receive one or a plurality of rotating speed signals and/or torque signals from the drive device, in particular from one or a plurality of rotating speed and/or torque sensors of the drive device, and/or from a motor and/or from the first and/or the second variator. The control unit can be configured to determine a rotating speed and/or torque by means of the rotating speed signal and/or the torque signal. The control unit can be configured to set and/or adjust the rotating speed and/or torque of the drive device, in particular of the motor and/or of the first and/or the second variator, in particular to set and/or adjust a predefinable rotating speed and/or a predefinable torque. The control unit can be configured to set and/or adjust the rotating speed of a first power output.

The shifting elements, in particular the first and/or the second and/or a third and/or a fourth and/or a fifth and/or a sixth and/or a seventh shifting element, can be connected for signaling and/or operatively coupled, and/or connected for signal transmission and/or data transmission, to the control unit. Specifically, each shifting element can comprise a valve or a valve assembly, in particular a control valve, or an actuator for actuating and/or setting and/or adjusting the respective assigned shifting element. The valve or the valve assembly or the actuator can be connected and/or operatively coupled to the respective assigned shifting element. The control unit can be connected for signaling and/or operatively coupled and/or connected for signal transmission and/or data transmission, to the valve or the valve assembly or the actuator of the respective assigned shifting element. The control unit can be configured to actuate and/or set and/or adjust the shifting element, in particular by way of the respective assigned valve or the valve assembly or the actuator. The control unit can be configured to set and/or adjust the shifting element, in particular by way of the respective assigned valve or the valve assembly or the actuator, to the first position, thus the opened state, or the second position, thus the closed state, in particular also to move said shifting element from the first to the second position and vice versa.

Specifically, the drive device can be suitable for the working machine, in particular a working machine driven by the motor and/or by hybrid power and/or electrically and/or hydraulically. Moreover, the drive device can be disposed on and/or in the working machine.

The first transmission unit can comprise one planetary coupling transmission. The first transmission unit, in particular the planetary coupling transmission, can comprise at least or one first and one second planetary transmission. The first and the second planetary transmission can be coupled to one another. The first and/or the second planetary transmission can also be designed as a double planet carrier transmission. However, the first transmission unit can also be designed as a Ravigneaux gear set and/or as a Lepelletier transmission and/or as any other planetary coupling transmission. The first transmission unit, in particular the planetary coupling transmission or the first and the second planetary transmission, can be coupled in such a manner that the first transmission unit has the first and the second input side and the first and the second output side.

Specifically, in particular as a first output side, a first planet carrier of the first planetary transmission can be connected to a second ring gear of the second planetary transmission. Specifically, the first planet carrier of the first planetary transmission and the second ring gear of the second planetary transmission can be connectable, or connected, to the first output side, preferably to the first drive output element or to the first output shaft. Alternatively, the reverse may be the case. A first ring gear of the first planetary transmission can be connected to a second planet carrier of the second planetary transmission, in particular as a first input side. Specifically, the first ring gear of the first planetary transmission and the second planet carrier of the second planetary transmission can be connectable, or connected, to the first input side, preferably to the first drive element or to the first input shaft. Alternatively, the reverse may be the case.

Alternatively, the first planet carrier of the first planetary transmission can be connected to the second planet carrier of the second planetary transmission, in particular as the first input side, and a first ring gear of the first planetary transmission can be connected to a second ring gear of the second planetary transmission, in particular as the first output side, or vice versa. Specifically, the first ring gear of the first planetary transmission and the second ring gear of the second planetary transmission can be connectable, or connected, to the first output side, preferably to the first drive output element or to the first output shaft. Specifically, the first planet carrier of the first planetary transmission and the second planet carrier of the second planetary transmission can be connectable, or connected, to the first input side, preferably to the first drive element or to the first input shaft. Alternatively, the reverse may be the case.

Alternatively, a first double planet carrier of the first planetary transmission can be connected to the second planet carrier of the second planetary transmission, in particular as the first input side, and a first ring gear of the first planetary transmission can be connected to a second ring gear of the second planetary transmission, in particular as the first output side, or vice versa. Specifically, the first ring gear of the first planetary transmission and the second ring gear of the second planetary transmission can be connectable, or connected, to the first output side, preferably to the first drive output element or to the first output shaft. Specifically, the first double planet carrier of the first planetary transmission and the second planet carrier of the second planetary transmission can be connectable, or connected, to the first input side, preferably to the first drive element or to the first input shaft. Alternatively, the reverse may be the case.

Alternatively, the first double planet carrier of the first planetary transmission can be connected to a second ring gear of the second planetary transmission, in particular as a first output side, and a first ring gear of the first planetary transmission can be connected to a second planet carrier of the second planetary transmission, in particular as a first input side, or vice versa. The first sun gear of the first planetary transmission can be designed as the second input side of the first transmission unit, preferably the second input side of the planetary coupling transmission, and the second sun gear of the second planetary transmission can be designed as the second output side of the first transmission unit, preferably the second output side of the planetary coupling transmission, or vice versa. In other words, the first transmission unit, preferably the planetary coupling transmission, particularly preferably the coupled first and second planetary transmissions, can thus advantageously have four degrees of freedom, in particular the first and the second input side and the first and the second output side.

The first variator, by way of, or by, the drive, and the drive, by way of, or by, the seventh shifting element, can be connectable, or connected, to the first input side of the first transmission unit, preferably the first input side of the planetary coupling transmission. Alternatively, a motor can be connectable, or connected, to the drive, and the drive can be connectable, or connected, to the first input side of the first transmission unit, preferably to the first input side of the planetary coupling transmission. Alternatively or additionally, the motor can be connectable, or connected, to the first variator by way of, or by, the drive. Alternatively or additionally, the first variator can be connectable, or connected, to the drive. Alternatively or additionally, the second variator can be connected to the second input side of the first transmission unit, preferably to the second input side of the planetary coupling transmission, particularly preferably to the first sun gear of the first planetary transmission.

The first and the second input side can be drivable. Force and/or torque and/or rotating speed can be directable into, or transmittable to, the first transmission unit by way of the input sides. The first and the second output sides can be a first and a second output shafts. The output sides can be drivable. Force and/or torque and/or rotating speed can be directable out of, or transmittable from, the first transmission unit by way of the output sides.

Specifically, the first output side, in particular the first output shaft, of the first transmission unit can be connectable, or connected, to the second transmission unit with the third, or by the third, input side. Likewise, the second output side, in particular the second output shaft, of the first transmission unit can be connectable, or connected, to the second transmission unit with the fourth, or by the fourth, input side. The first output side and the third input side can be designed as a third input shaft. The second output side and the fourth input side can be designed as a fourth input shaft. The second transmission unit can on the output side be connectable, or connected, to the drive output, in particular the drive output shaft. Overall, the first transmission unit can be connectable, or connected, to the drive output, in particular the drive output shaft, by way of the second transmission unit.

The first variator can be connected to the drive directly or by way of a, or with a, or by a, first transmission stage, in particular a fifth spur gear stage and/or three or four or more gearwheels and/or a further planetary transmission and/or any other transmission. The second variator can be connected to the second input side and/or a seventh input side directly or by way of a, or with a, or by a, second transmission stage, in particular a sixth spur gear stage and/or three or four or more gearwheels and/or a further planetary transmission and/or any other transmission. The second transmission stage can be connected to the second drive element, in particular the second input shaft.

The drive, in particular the drive shaft, and/or the drive output, in particular the drive output shaft, can be a solid shaft. The drive and the drive output can be disposed to be coaxial with one another. The drive output can be connected to a propulsion drive. In particular, the drive output can be connected to the propulsion drive with one or a plurality of, or by one or a plurality of, further transmission stages. The one or the plurality of further transmission stages can be designed as further spur gear stages and/or further gearwheel pairs and/or three or more gearwheels and/or further planetary transmissions or any other transmissions. The second input shaft can be designed as a hollow shaft. Moreover, the second input shaft and the drive can be disposed so as to be coaxial with one another. Likewise, the drive can be disposed in the second input shaft, in particular disposed so as to be freely rotatable in the latter. Moreover, the second input shaft can be disposed so as to be coaxial with the drive. Moreover, the third transmission unit, in particular likewise the first and/or the second transmission unit, can be disposed so as to be axially parallel to and/or coaxial with the drive.

It is essential for the disclosure that the drive device advantageously has an optimum transmission spread, in particular as a result of the combination of the first and the second transmission unit. Moreover, the drive device can advantageously be implemented as a structurally simple drive device, which moreover is of a compact construction. Furthermore, the drive device can be of a modular construction, as a result of which, for example, the first and/or the second transmission unit can be interchanged in a simple manner. Specifically, minimal installation space and a construction with an optimally simple structure of the drive device can advantageously be achieved as a result. Moreover, the smaller installation space makes it possible for the towing vehicle to become more agile and more compact on account of the shorter distance between wheels and/or for the saved installation space to be able to be used for other functions/modules. A substantial advantage of this disclosure is that, taking into account modular transmission units, the same functions as compared to multi-step transmissions can be fulfilled by the same modules even in the case of continuously variable transmissions and, moreover, the continuously variable transmissions can be constructed in accordance with requirements. What should be mentioned here is the increase in the spread by the second transmission unit, the change in the direction of travel by changing the direction of rotation with the third transmission unit, and the starting by the fourth transmission unit. In contrast, progressive gear spreading is desirable in automobiles. Therefore, a combination of two transmission units tends to be disadvantageous in the latter, because a geometric spreading is enforced thereby, so to speak.

In a design embodiment of the disclosure, the first transmission unit, in particular the planetary coupling transmission, has two different stationary transmission ratios. As a result, the four degrees of freedom can advantageously be implemented.

The different stationary transmission ratios advantageously enable different transmission ratios and/or modes of the drive device, in particular while enabling a compact construction. Furthermore, the above-mentioned advantages of the drive device can be implemented.

In a design embodiment of the disclosure, the second transmission unit comprises a first spur gear stage and/or a second spur gear stage and/or a third planetary transmission, and at least a first and a second shifting element.

The second transmission unit can specifically comprise the following embodiments, for example: the first spur gear stage and the first and the second shifting element, only these components (first example embodiment), or the first and the second spur gear stage and the first and the second shifting element, only these components (second example embodiment), or the first spur gear stage and the first planetary transmission, and the first and the second and the third shifting element, only these components (third example embodiment).

In the first example embodiment: the first shifting element can be connectable, or connected, to the third input side, and/or the second shifting element can be connectable, or connected, to the fourth input side, and/or the first shifting element can be connectable, or connected, to the first spur gear stage, and/or the second shifting element can be connectable, or connected, to the first spur gear stage, and/or the first output side and/or the third input side can be connectable, or connected, to the first spur gear stage by, or by way of, the first shifting element, and/or the second output side and/or the fourth input side can be connectable, or connected, to the first spur gear stage by the, or by way of the, second shifting element, and/or the first spur gear stage can be connected to the drive output, in particular to the drive output shaft, and/or the first and/or the second shifting element can be connectable, or connected, to the drive output, in particular to the drive output shaft, by way of the, or with the, first spur gear stage.

In the second example embodiment, additionally or alternatively to the first example embodiment: the first shifting element can be connectable, or connected, to the third input side, and/or the second shifting element can be connectable, or connected, to the fourth input side, and/or the first shifting element can be connectable, or connected, to the first spur gear stage, and/or the second shifting element can be connectable, or connected, to the second spur gear stage, and/or the first output side and/or the third input side can be connectable, or connected, to the first spur gear stage by the, or by way of the, first shifting element, and/or the second output side and/or the fourth input side can be connectable, or connected, to the second spur gear stage by the, or by way of the, second shifting element, and/or the first and the second spur gear stage can be connected to the drive output, in particular to the drive output shaft, and/or the first shifting element can be connectable, or connected, to the drive output, in particular to the drive output shaft, by way of the, or with, the first spur gear stage, and/or the second shifting element can be connectable, or connected, to the drive output, in particular to the drive output shaft, by way of the, or with the, second spur gear stage.

In the third example embodiment, additionally or alternatively to the first and/or the second example embodiment: the first shifting element can be connectable, or connected, to the third input side, and/or the second shifting element can be connectable, or connected, to the fourth input side, and/or the third shifting element, which can be designed in particular as a brake, can be connected to the third planetary transmission, preferably to a component of the third planetary transmission, particularly preferably to the third ring gear of the third planetary transmission, and/or the first shifting element can be connectable, or connected, to the third planetary transmission, preferably to a component of the third planetary transmission, particularly preferably to the third planet carrier of the third planetary transmission, and/or the second shifting element can be connectable, or connected, to the third planetary transmission, preferably to a component of the third planetary transmission, particularly preferably to the third planet carrier of the third planetary transmission, and/or the first output side and/or the third input side can be connectable to the third planetary transmission, preferably to a component of the third planetary transmission, particularly preferably to the third planet carrier of the third planetary transmission, by the first shifting element, and/or the second output side and/or the fourth input side can be connectable to the third planetary transmission, preferably to a component of the third planetary transmission, particularly preferably to the third planet carrier of the third planetary transmission, by the second shifting element, and/or the third planetary transmission, preferably a component of the third planetary transmission, particularly preferably the third planet carrier of the third planetary transmission, can be connected to the first spur gear stage, and/or the second output side can be connected to the third planetary transmission, preferably to a component of the third planetary transmission, particularly preferably to the third sun of the third planetary transmission, and/or the first spur gear stage can be connected to the drive output, in particular to the drive output shaft, and/or the first and/or the second shifting element can be connectable, or connected, to the drive output, in particular to the drive output shaft, by way of the, or with the, first spur gear stage.

In a design embodiment of the disclosure, the drive device comprises a third transmission unit, in particular a reversing unit or powershift reversing unit. The third transmission unit has a fifth and a sixth input side and a fifth output side. The drive device, in particular the fifth input side, can comprise a fifth drive element or be designed as a fifth drive element. The drive device, in particular the sixth input side, can comprise a sixth drive element or be designed as a sixth drive element. The fifth and/or the sixth input side, in particular the fifth and/or the sixth drive element, can be designed as, and/or comprise, for example a shaft, in particular a fifth and/or a sixth input shaft, and/or a gearwheel and/or a shifting element. The drive device, in particular the fifth output side, can comprise a fifth drive output element or be designed as a fifth drive output element. The fifth output side, particularly preferably the fifth drive output element, can be designed as, and/or comprise, for example a shaft, in particular a fifth output shaft, and/or a gearwheel and/or a shifting element. Alternatively, the fifth output side, in particular the fifth drive output element, and the first input side, in particular the first drive element, can be designed as a common component, in particular as the first input shaft.

The third transmission unit can, in particular on the input side, be connectable, or connected, to the drive. The third transmission unit can, in particular on the input side, be connectable, or connected, to the drive. Specifically, the drive can be connectable, or connected, to the fifth input side. Likewise, the drive can be connectable, or connected, to the sixth input side by way of the first transmission stage. Additionally, the third transmission unit can be connectable, or connected, to the first variator, in particular by way of the first, or with the first, transmission stage. The third transmission unit can, in particular on the output side, be connectable, or connected, to the first transmission unit. The third transmission unit can be designed to reverse the direction of travel. The third transmission unit can be powershiftable or non-powershiftable. Moreover, the third transmission unit, in particular likewise the first and/or the second transmission unit, can be disposed so as to be axially parallel to and/or coaxial with the drive.

A direction of rotation of the first output shaft can be reversible by the third transmission unit.

Specifically, the motor can be connectable, or connected, to the third transmission unit, in particular to the fifth and the sixth input side, by the, or by way of the, drive. Specifically, the third transmission unit, in particular the fifth and the sixth output side, can be connectable, or connected, to the first input side, preferably to the first drive element, particularly preferably to the first input shaft, of the first transmission unit. The third transmission unit can comprise, for example, the first transmission stage and a fourth and a fifth shifting element. However, the third transmission unit can also comprise only the fourth and the fifth shifting element. The third transmission unit can in particular be activatable by the fourth and/or the fifth shifting element. The fifth and the sixth input side can be connectable, or connected, to the drive. The fifth input side can be connectable, or connected, to the drive. The fifth input side can be connected to the fourth shifting element. Specifically, the fourth shifting element can be connectable, or connected, to the drive. The sixth input side can be connectable, or connected, to the drive. The sixth input side can be connectable, or connected, to the first transmission stage. Specifically, the first transmission stage can be connectable, or connected, to the drive. The first transmission stage can be connectable, or connected, to the fifth shifting element. The drive can be connectable, or connected, to the fifth shifting element by the, or by way of the, first transmission stage. The fifth output side can be connectable, or connected, to the first input side. Specifically, the fifth output side and the first input side can be connected by way of the, or with the, first input shaft. Likewise, the fourth and/or the fifth shifting element can be connectable, or connected, to the fifth output side, in particular to the fifth drive output element, or be designed as the fifth output side. Alternatively, the fourth and/or the fifth shifting element can be connectable, or connected, to the first input shaft, in particular if the fifth output side and the first input side are designed as a common component. The first input shaft can be designed as a hollow shaft. Moreover, the first and/or the fourth input shaft and/or the drive can be disposed so as to be mutually coaxial. Likewise, the first and/or the fourth input shaft can be disposed inside one another, in particular so as to be freely rotatable inside one another. Specifically, the first input shaft can be disposed in the fourth input shaft, in particular disposed so as to be freely rotatable in the latter. Likewise, the drive can be disposed in the first input shaft, in particular disposed so as to be freely rotatable in the latter.

The first transmission stage can specifically comprise three or four or more gearwheels with at least one idling gearwheel. As a result, the third transmission unit can advantageously be designed as a preliminary variator stage for the second transmission unit. The third transmission unit can likewise be embodied in a planetary construction mode. The third transmission unit can comprise, for example, a further planetary transmission and the fourth and the fifth shifting element. The fourth shifting element can on the input side be connectable, or connected, to the drive. The fourth shifting element can on the output side be connectable, or connected, to the planet carrier of the further planetary transmission. The fifth shifting element can in particular be designed as a brake. The fifth shifting element can be connected to the ring gear of the further planetary transmission. The sun gear of the further planetary transmission can be connectable, or connected, to the fifth output side. The fifth output side can be connectable, or connected, to the first input side. Specifically, the fifth output side and the first input side can be connected by way of the, or with the, first input shaft. Owing to the planetary construction mode, a particularly short axial installation length is achieved, this also having an advantageous effect on the overall installation length of the shift transmission assembly.

In a design embodiment of the disclosure, the drive device comprises a fourth transmission unit, in particular a start-up unit. The fourth transmission unit has at least one seventh input side and at least one sixth output side. The fourth transmission unit can moreover be connectable, or connected, to the first transmission unit and/or to the layshaft. The fourth transmission unit can be connectable, or connected, to the first transmission unit, preferably to the second input side, particularly preferably to the second input shaft or the second drive element. The fourth transmission unit can, in particular on the output side, be connectable, or connected, to the layshaft. The fourth transmission unit can, in particular on the input side, be connectable, or connected, to the second variator. The second variator can be connected directly or by way of the second transmission stage to the second input side, in particular to the second drive element or to the second input shaft, and/or to the seventh input side. The second transmission stage can be connectable, or connected, to the second input side, in particular to the second drive element or the second input shaft.

The fourth transmission unit can comprise, for example, a third spur gear stage and a fourth spur gear stage, and at least one sixth shifting element. Herein: the seventh input side can be in particular the second drive element or the second input shaft and/or the third spur gear stage, the third spur gear stage can be connectable, or connected, to the second variator, in particular to the second transmission stage, and/or to the second input side, in particular to the second drive element or the second input shaft, and/or the third spur gear stage can be connected to the fourth spur gear stage, in particular engage with the fourth spur gear stage or be connected thereto by way of a shaft, and/or the fourth spur gear stage can be connected to the sixth shifting element, and/or the fourth spur gear stage can be connectable to the layshaft with the sixth, or by the sixth, shifting element, and/or the layshaft can be connectable, or connected, to the drive output, in particular the drive output shaft.

Force and/or torque and/or rotating speed can be directable into or transmittable to the fourth transmission unit by way of the third spur gear stage. Force and/or torque and/or rotating speed can be directable or transmittable from the fourth transmission unit into/to the layshaft by way of the sixth shifting element, and by way of the layshaft into/to the drive output, in particular the drive output shaft. The fourth transmission unit, in particular the sixth shifting element, can be connectable, or connected, to the drive output and/or the layshaft. The sixth shifting element can be designed as an output-side link, in particular to the drive output and/or the layshaft.

Alternatively, the fourth transmission unit can comprise the third and the fourth spur gear stage and the fourth planetary transmission and the sixth shifting element. Alternatively or additionally: the seventh input side can be the fourth ring gear of the fourth planetary transmission, the fourth planetary transmission, preferably a component of the fourth planetary transmission, particularly preferably the fourth ring gear of the fourth planetary transmission, can be connected to the second variator and/or the second transmission stage, and/or the second transmission stage and the fourth ring gear can engage, in particular mesh with one another, or the fourth ring gear can be designed as a gearwheel or component of the second transmission stage, in particular of the sixth spur gear stage, and/or the fourth ring gear can be connectable, or connected, to the second input side, in particular to the second drive element or to the second input shaft, and/or the fourth sun of the fourth planetary transmission can be connected to the drive, and/or the fourth planet carrier of the fourth planetary transmission can be connected to the third spur gear stage, and/or the third spur gear stage can be connected to the fourth spur gear stage, in particular engage with the fourth spur gear stage or be connected thereto by way of a shaft, and/or the fourth spur gear stage can be connected to the sixth shifting element, and/or the fourth spur gear stage can be connectable to the layshaft with the sixth, or by the sixth, shifting element, and/or the second variator can be connectable, or connected, to the layshaft by the, or by way of the, sixth shifting element, and/or the layshaft can be connectable, or connected, to the drive output.

The sixth output side can be the sixth shifting element or the sixth output side, in particular a sixth drive output element, can be connected to the sixth shifting element.

The layshaft can be a solid shaft or a hollow shaft. The layshaft can be disposed so as to be axially parallel to and/or coaxial with the first and/or the second input shaft and/or the drive output, in particular the drive output shaft. The layshaft can be connected to the drive output by way of a coupling gearwheel, in particular by way of a coupling gearwheel that meshes with the first spur gear stage. However, the layshaft can also be connectable, or connected, to the drive output with a third, or by way of a third, transmission stage, for example a seventh spur gear stage and/or three or four or more gearwheels and/or a further planetary transmission and/or any other transmission, and/or a further shifting element. Moreover, the layshaft can be connected to the propulsion drive, in particular to the front-axle drive. The layshaft can be connectable, or connected, to a further shaft with a fourth, or by way of a fourth, transmission stage, for example an eighth spur gear stage and/or three or four or more gearwheels and/or a further planetary transmission and/or any other transmission, and/or a further shifting element. The layshaft or the further shaft can be connected to the first differential or the front-axle differential. Specifically, the layshaft or the further shaft can be connected to a toothing of a front-axle drive. For example, a front-axle drive wheel can be co-rotationally connected to the layshaft or the further shaft, or be selectively co-rotationally connectable to and releasable from the latter. As a result, a compact and structurally simple design of the drive device assembly can advantageously be implemented.

In a design embodiment of the disclosure, the first variator is connectable to the first input side by way of the, or by the, drive and the seventh shifting element. The first variator can be connectable, or connected, by way of the, or by the, drive, and the drive can be connectable, or connected, by way of the, or by the, seventh shifting element, to the first input side of the first transmission unit, preferably to the first input side of the planetary coupling transmission, particularly preferably to the first drive element or the first input shaft. As a result, the drive device can be operated purely electrically in a simple manner.

In a design embodiment of the disclosure, the first variator is designed as a first electric motor, and the second variator is designed as a second electric motor. Alternatively, the first and the second variator can be designed as a hydrostat, wherein the hydrostat comprises in particular a hydraulic pump and a hydraulic motor. The first and the second variator can thus be designed and/or operable as a hydraulic pump or hydraulic motor. Alternatively or additionally, the first and/or the second variator can be designed as a fuel cell. The first and/or the second variator, in particular the first and/or the second electric motor, can be DC- and/or AC-operated synchronous and/or asynchronous machines with permanent and/or electrical excitation, particularly preferably be permanently excited AC synchronous machines. The first and/or the second variator can be operable as motors or as generators. The first and/or the second variator can drive the drive device by way of a force and/or a rotating speed and/or a torque. The first and/or the second variator can in each case comprise a drive output shaft, in particular a first and a second drive output shaft. The first variator can on the drive output side, thus in particular with the first drive output shaft, be connectable, or connected, to the drive. The second variator can on the drive output side, thus in particular with the second drive output shaft, be connectable, or connected, to the first and/or the second and/or the third or the common input. For example, a first rotor of the first variator, in particular of the first electric motor, and/or a second rotor of the second variator, in particular of the second electric motor, can be connected to the respective drive output shaft. The first and/or the second variator, in particular the first and/or the second electric motor, can be embodied as a torque motor. The first and/or the second variator can additionally be designed as a generator.

The drive device can moreover comprise a power electronics unit and/or an energy store. The power electronics unit can be used to transmit power, in particular electrical power, between the first and/or the second variator, in particular a first and/or a second electric motor, and/or the energy store. The power electronics unit can be integrated into the control unit or, as external unit(s), be actuatable by the control unit. The power electronics unit can comprise an electronic control apparatus and/or an inverter and/or a voltage transformer. During operation, the inverter and/or the voltage transformer can convert the voltage of the energy store into a voltage or energy or power required by the first and/or the second energy machine. This procedure can be reversed for the purposes of charging the energy store. The energy store can be actuatable by the electronic control apparatus so as to store electrical energy and/or power, and/or deliver the latter to the first and/or the second variator. The control unit or the electronic control apparatus and/or the first and/or the second energy machine, in particular the first and/or the second electric motor, can be electrically connected and/or electrically couplable, or coupled, to the power electronics unit and/or to the energy store. The power electronics unit, in particular the electronic control apparatus, can be integrated into the control unit. The first and/or the second variator can be designed as a generator, and in particular charge the energy store in a recuperation mode. The energy store can be designed as a battery and/or a rechargeable battery and/or a supercapacitor and/or a fuel cell and/or any other device for storing electrical energy.

Alternatively or additionally, the first and the second variator can be designed as a hydrostat. In other words, both the first and the second variator conjointly can be designed as one hydrostat unit. The first and the second variator can be designed alternately as a hydraulic pump and a hydraulic motor. The hydrostat can have a hydraulic pump, in particular an adjustable hydraulic pump as input element and have a hydraulic motor as output element. The hydraulic motor can be drivable by the, or by way of the, or with the, hydraulic pump, in particular be drivable by a hydraulic power from the hydraulic pump. The hydraulic pump can be drivable by a force and/or a rotating speed and/or a torque of the motor. The force and/or rotating speed and/or the torque of the hydraulic motor can be directed into the first and/or the second transmission unit and/or the fourth transmission unit. By adjusting the hydraulic pump, the output power, thus in particular the force and/or the rotating speed and/or the torque, of the drive device, in particular at the drive output, can be set. The hydraulic pump can have a pump wheel with an adjustable hydraulic geometry. Alternatively, other means for adjusting the hydraulic pump, by which the hydraulic power of the hydraulic pump can be set, can be provided. As a result, a hybrid drive device can advantageously be implemented in a simple structural manner.

In a design embodiment of the disclosure, the drive device comprises a motor. The motor can be connected to the first input side and to the first variator by way of the, or by the, drive. Alternatively or additionally, the motor can be connected to the fifth and the sixth input side and to the first variator and/or to the fourth ring gear by way of the, or by the, drive. The motor can be designed as an internal combustion engine. Alternatively or additionally, the motor can be an electric motor, in particular a third electric motor. As a result, the drive device, in particular also the working machine, can advantageously be of modular construction and/or be drivable by a hybrid drive. The control unit can be connected to the motor for signaling and/or be operatively coupled to the latter, and/or be connected to the latter for signal transmission and/or data transmission. As a result, the drive device, in particular also the working machine, can advantageously be of modular construction.

In a design embodiment of the disclosure, the first and/or the second and/or the third and/or the fourth transmission unit have a conduit or a plurality of conduits, in particular one or a plurality of central conduits, for the drive, in particular the drive shaft. The drive, in particular the drive shaft, can additionally be designed as a power take-off drive shaft (PTO drive shaft), in particular also be able to be utilized as the latter. The drive, in particular the drive shaft, and the power take-off drive shaft can be designed as one shaft, in particular a common shaft. The drive, in particular the drive shaft, can be embodied as a solid shaft. The conduit or conduits, in particular the central conduit or conduits, can be formed as one or a plurality of shaft feedthroughs, in particular one or more central shaft feedthroughs, for the drive, in particular the drive shaft.

The first and/or the second and/or the third and/or the fourth transmission unit can thus have one or a plurality of shaft feedthroughs, in particular one or a plurality of central shaft feedthroughs, for the drive, in particular the drive shaft. Specifically: the first and/or the second and/or the third sun and/or the first and/or the second and/or the fourth input shaft, and/or the first and/or the fourth shifting element can have in each case conduits, in particular shaft feedthroughs, for the drive, in particular the drive shaft. The drive, in particular the drive shaft, can thus extend through these components. Moreover, the drive, in particular the drive shaft, can be disposed so as to be coaxial with the first and/or the second and/or the third and/or the fourth input shaft, and/or be disposed so as to be freely rotatable within the latter. In this way, a direct and therefore particularly energy-efficient transmission of the torque and/or the force and/or the rotating speed to the first power output of the drive device or working machine is possible.

In a design embodiment of the disclosure, the motor and/or the first variator is connectable, or connected, to the first power output, in particular connectable, or connected, to the first power output with the eighth, or by the eighth, shifting element and/or the ninth shifting element. The first power output can comprise a PTO unit, or be designed as a PTO unit. The PTO unit can comprise a PTO gear and/or a PTO shaft. The motor can be connected to the eighth and/or the ninth shifting element by way of the drive, in particular the drive shaft. The first variator can be connected to the ninth shifting element by way of the drive, in particular the drive shaft. The eighth and/or the ninth shifting element can be connected to the first power output, in particular the PTO gear and/or the PTO shaft, in particular by way of the drive. The eighth and/or the ninth shifting element can connect the drive, in particular the drive shaft, to the first power output, in particular the PTO gear and/or the PTO shaft. The first power output, preferably the PTO unit, particularly preferably the PTO gear, can thus on the drive side be connectable, or connected, to the drive, in particular the drive shaft, and/or the PTO drive shaft, in particular by way of or by the eighth and/or the ninth shifting element. Moreover, the first power output, preferably the PTO unit, particularly preferably the PTO gear, can on the drive output side be connectable, or connected, to the PTO shaft. The first power output is drivable by the motor and/or the first variator. As a result, a compact and/or modular and/or structurally simple design embodiment of the drive device, in particular of the first power output, can advantageously be achieved.

In a design embodiment of the disclosure, the drive device or the working machine comprises a control unit. The control unit is described in detail above and below.

The disclosure furthermore relates to a transmission housing assembly having a drive device, in particular a drive device according to one or more embodiments disclosed herein. The transmission housing assembly comprises a first housing module with the first transmission unit and a second housing module with the second transmission unit, and the first and second housing module are disposed along or in the direction of the drive, in particular of the drive shaft. Specifically, the first and the second housing modules can be disposed successively and/or directly adjacent along the drive or in the direction of the drive, in particular of the drive shaft. The working machine can comprise the transmission housing assembly.

The layshaft, the latter in particular at least in part, and/or the second variator can additionally be disposed in the first housing module. The first housing module can have inner bearing points, for example in the form of webs or other bearing and/or fastening installations. The first transmission unit, in particular components of the first transmission unit, can be mountable at and/or on and/or in the bearing points. Additionally, the layshaft, the latter in particular at least in part, and/or the second variator can be mountable at and/or on and/or in the bearing points.

The layshaft, the latter in particular at least in part, and/or the drive output, in particular the drive output shaft, and/or the first variator can additionally be disposed in the second housing module. The second housing module can have inner bearing points, for example in the form of webs or other bearing and/or fastening installations. The second transmission unit, in particular components of the second transmission unit, can be mountable at and/or on and/or in the bearing points. Additionally, the layshaft, the latter in particular at least in part, and/or the drive output, in particular the drive output shaft, and/or the first variator can be mountable at and/or on and/or in the bearing points. The first housing module can have an input-side housing wall. The input-side housing wall of the first housing module can be any housing wall of the first housing module, but in particular the housing wall of which the shaft bearing planes are disposed orthogonally to the drive, in particular the drive shaft, and/or the clutch drive shaft.

The input-side housing wall of the first housing module can have at least one first input opening. The first input opening can be designed for linking and/or connecting the first input side to the drive, in particular the drive shaft, and/or for linking and/or connecting the second input side, in particular the second input shaft, to the second variator. The drive and/or the second input shaft can be disposed in the first input opening of the input-side housing wall of the first housing module. Specifically, the drive, in particular the drive shaft, and/or the second input shaft can extend through the first input opening.

Alternatively or additionally, the input-side housing wall of the first housing module can have a second input opening. The second input opening can be designed for feeding through and/or linking and/or connecting the layshaft. The layshaft can be disposed in the second input opening of the input-side housing wall of the first housing module. Specifically, the layshaft can extend through the second input opening.

The first housing module can have an output-side housing wall. The output-side housing wall of the first housing module can be any housing wall of the first housing module.

The output-side housing wall of the first housing module, in particular the shaft bearing plane thereof, can be disposed parallel to the input-side housing wall of the first housing module, in particular the shaft bearing plane of the latter, and/or orthogonally to the drive, in particular the drive shaft, and/or the clutch drive shaft.

The output-side housing wall of the first housing module can have a first output opening. The first output opening can be designed for linking and/or connecting the second output side to the fourth input side, and/or for linking and/or connecting the first input side to the fifth output side, and/or for feeding through the drive. The first and/or the third and/or the fourth input shaft and/or the drive can be disposed in the first output opening. Specifically, the first and/or the third and/or the fourth input shaft and/or the drive can extend through the first output opening.

Alternatively, the output-side housing wall of the first housing module can have a second output opening. The second output opening can be designed for linking and/or connecting the first output side to the third input side. The third input shaft can be disposed in the second output opening. Specifically, the third input shaft can extend through the second output opening.

Alternatively or additionally, the output-side housing wall of the first housing module can have a third output opening. The third output opening can be designed for feeding through and/or linking and/or connecting the layshaft. The layshaft can be disposed in the third output opening. Specifically, the layshaft can extend through the third output opening.

The second housing module can have an input-side housing wall. The input-side housing wall of the second housing module can be any housing wall of the second housing module. The input-side housing wall of the second housing module, in particular the shaft bearing plane thereof, can be disposed parallel to the input-side housing wall of the first housing module, in particular the shaft bearing plane of the latter, and/or orthogonally to the drive, in particular the drive shaft. The input-side housing wall of the second housing module can have a third input opening. The third input opening can be designed for linking and/or connecting the second output side to the fourth input side, and/or for linking and/or connecting the first input side to the fifth output side, and/or for feeding through the drive. The first and/or the third and/or the fourth input shaft and/or the drive can be disposed in the third input opening. Specifically, the first and/or the third and/or the fourth input shaft and/or the drive can extend through the third input opening.

The center line of the first output opening and the center line of the second input opening can be coaxial or axially parallel. Alternatively or additionally, the input-side housing wall of the second housing module can have a fourth input opening. The fourth input opening can be designed for feeding through the layshaft, and/or for linking and/or connecting the layshaft to the drive output, in particular the drive output shaft. The layshaft can be disposed in the fourth input opening of the input-side housing wall of the second housing module. Specifically, the layshaft can extend through the fourth input opening.

The center line of the second output opening and the center line of the third input opening can be coaxial or axially parallel.

The output-side housing wall of the first housing module and the input-side housing wall of the second housing module can alternatively be designed as a first common housing wall of the first and the second housing module. The first common housing wall can have a first conduit opening. The first output opening and the third input opening can be designed as the first conduit opening. In this case, the first conduit opening assumes the function of the first output opening and of the third input opening. The first common housing wall can have a second conduit opening. The second output opening and the fourth input opening can be designed as the second conduit opening. In this case, the second conduit opening assumes the function of the second output opening and of the fourth input opening. The first and/or the third and/or the fourth input shaft and/or the drive can be disposed in the first conduit opening. Specifically, the first and/or the third and/or the fourth input shaft and/or the drive can extend through the first conduit opening. The layshaft can be disposed in the second conduit opening. Specifically, the layshaft can extend through the second conduit opening.

The second housing module can have an output-side housing wall. The output-side housing wall of the second housing module can be any housing wall of the second housing module. The output-side housing wall of the second housing module, in particular the shaft bearing plane thereof, or the second common housing wall, in particular the shaft bearing plane thereof, can be disposed parallel to the input-side housing wall of the first and/or the second housing module, in particular the shaft bearing plane of the latter, and/or orthogonally to the drive, in particular the drive shaft.

The output-side housing wall of the second housing module can have a fourth output opening. The fourth output opening can be designed for linking and/or connecting the first input side to the fifth output side, and/or for feeding through the drive. The first input shaft and/or the drive can be disposed in the fourth output opening. Specifically, the first input shaft and/or the drive can extend through the fourth output opening.

Alternatively or additionally, the output-side housing wall of the second housing module can have a fifth output opening. The fifth output opening can be designed for feeding through and/or for linking and/or connecting the drive output, in particular the drive output shaft. The drive output, in particular the drive output shaft, can be disposed in the fifth output opening of the output-side housing wall of the second housing module. Specifically, the drive output, in particular the drive output shaft, can extend through the fifth output opening.

In a design embodiment of the disclosure, the transmission housing assembly comprises a third housing module with the third transmission unit, and the first and second and third housing module are disposed along the drive. Specifically, the first and second and third housing module can be disposed successively and/or directly adjacent along or in the direction of the drive, in particular of the drive shaft. Specifically, the second and the third housing module can be disposed directly adjacent.

The fifth and the sixth shifting element and the second transmission stage can be disposed in the third housing module. Alternatively, the third transmission unit can be disposed in a planetary construction mode in the third housing module. The third housing module can have inner bearing points, for example in the form of webs or other bearing and/or fastening installations. The third transmission unit, in particular components of the third transmission unit, can be mountable at and/or on and/or in the bearing points.

The third housing module can have an input-side housing wall. The input-side housing wall of the third housing module can be any housing wall of the third housing module. The input-side housing wall of the third housing module, in particular the shaft bearing plane thereof, can be disposed parallel to the input-side housing wall of the first and/or the second housing module, in particular the shaft bearing planes of the latter, and/or orthogonally to the drive, in particular the drive shaft. The input-side housing wall of the third housing module can have a fifth input opening. The fifth input opening can be designed for linking and/or connecting the first input side to the fifth output side and/or for feeding through the drive. The first input shaft and/or the drive can be disposed in the fifth input opening. Specifically, the first input shaft and/or the drive can extend through the fourth input opening. The center line of the fourth output opening and the center line of the fifth input opening can be coaxial or axially parallel. The third housing module can have an output-side housing wall. The output-side housing wall of the third housing module can be any housing wall of the third housing module. The output-side housing wall of the third housing module, in particular the shaft bearing plane thereof, can be disposed parallel to the input-side housing wall of the first and/or the second and/or the third housing module, in particular the shaft bearing planes of the latter, and/or orthogonally to the drive, in particular the drive shaft.

Alternatively or additionally, the output-side housing wall of the third housing module can have a sixth output opening. The sixth output opening can be designed for feeding through the drive. The drive can be disposed in the sixth output opening. Specifically, the drive can extend through the sixth output opening.

The output-side housing wall of the second housing module and the input-side housing wall of the third housing module can alternatively be designed as a second common housing wall of the second and the third housing module. The second common housing wall can have a third conduit opening. The fourth output opening and the fifth input opening can be designed as the third conduit opening. In this case, the third conduit opening assumes the function of the fourth output opening and of the fifth input opening. The first input shaft and/or the drive can be disposed in the third conduit opening. Specifically, the first input shaft and/or the drive can extend through the third conduit opening.

Alternatively or additionally, the output-side housing wall of the third housing module can have a seventh output opening. The seventh output opening can be designed for feeding through and/or for linking and/or connecting the drive output, in particular the drive output shaft. The drive output, in particular the drive output shaft, can be disposed in the seventh output opening. Specifically, the drive output, in particular the drive output shaft, can extend through the seventh output opening.

In a design embodiment of the disclosure, the transmission housing assembly comprises a fourth housing module with the fourth transmission unit. The first and the second and the third and the fourth housing module are disposed along the drive. Specifically, the housing modules can be disposed successively and/or directly adjacent in the sequence of fourth and first and second and third housing module along or in the direction of the drive, in particular of the drive shaft. Specifically, the fourth and the first, and the first and the second, and the second and the third housing module can be disposed so as to be directly adjacent.

The layshaft can additionally be disposed in the fourth housing module. The fourth housing module can have inner bearing points, for example in the form of webs or other bearing and/or fastening installations. The fourth transmission unit, in particular components of the third transmission unit, and/or the layshaft can be mountable at and/or on and/or in the bearing points.

The fourth housing module can have an input-side housing wall. The input-side housing wall of the fourth housing module can be any housing wall of the fourth housing module. The input-side housing wall of the fourth housing module, in particular the shaft bearing plane thereof, can be disposed parallel to the input-side housing wall of the first and/or the second and/or the third housing module, in particular the respective shaft bearing plane of the latter, and/or orthogonally to the drive, in particular the drive shaft.

The input-side housing wall of the fourth housing module can have a sixth input opening. The sixth input opening can be designed for feeding through the drive. The drive can be disposed in the sixth input opening. Specifically, the drive can extend through the sixth input opening.

Alternatively or additionally, the input-side housing wall of the fourth housing module can have a seventh input opening. The seventh input opening can be designed for feeding through the layshaft. The layshaft can be disposed in the seventh input opening of the input-side housing wall of the fourth housing module. Specifically, the layshaft can extend through the seventh input opening.

The fourth housing module can have an output-side housing wall. The output-side housing wall of the fourth housing module can be any housing wall of the second housing module. The output-side housing wall of the second housing module, in particular the shaft bearing plane thereof, can be disposed parallel to the input-side housing wall of the first and/or the second and/or the third housing module, in particular the respective shaft bearing plane of the latter, and/or orthogonally to the drive, in particular the drive shaft.

The output-side housing wall of the fourth housing module can have an eighth output opening. The eighth output opening can be designed for feeding through the second input shaft and/or the drive, and/or for linking and/or connecting the second and/or the seventh input side. Alternatively or additionally, the eighth output opening can be designed for linking and/or connecting the fourth transmission unit to the first transmission unit. The second input shaft and/or the drive can be disposed in the eighth output opening. Specifically, the second input shaft and/or the drive can extend through the eighth output opening.

Alternatively or additionally, the output-side housing wall of the fourth housing module can have a ninth output opening. The ninth output opening can be designed for feeding through and/or linking and/or connecting the layshaft. The layshaft can be disposed in the ninth output opening of the output-side housing wall of the fourth housing module. Specifically, the layshaft can extend through the ninth output opening.

In this embodiment, thus if the transmission housing assembly comprises the first, the second, the third and the fourth housing module, the common housing walls can be designed and disposed differently as follows.

The output-side housing wall of the fourth housing module and the input-side housing wall of the first housing module can alternatively be designed as a third common housing wall of the first and the fourth housing module. The third common housing wall can have a fourth conduit opening. The eighth output opening and the first input opening can be designed as the fourth conduit opening. In this case, the fourth conduit opening assumes the function of the eighth output opening and of the first input opening. Alternatively or additionally, the third common housing wall can have a fifth conduit opening. The ninth output opening and the second input opening can be designed as the fifth conduit opening. In this case, the fifth conduit opening assumes the function of the ninth output opening and of the second input opening. The second input shaft and/or the drive, in particular the drive shaft, can be disposed in the fourth conduit opening. Specifically, the second input shaft and/or the drive, in particular the drive shaft, can extend through the fourth conduit opening. The layshaft can be disposed in the fifth conduit opening. Specifically, the layshaft can extend through the fifth conduit opening.

The first to seventh input openings and/or the first to ninth output openings and/or the first to fifth conduit openings can in each case be designed and/or embodied as a conduit, in particular central conduit. Specifically, the first to seventh input openings and/or the first to ninth output openings and/or the first to sixth conduit openings can in each case be designed and/or embodied as a shaft feedthrough, in particular central shaft feedthroughs, for the first and/or the second input shaft and/or the layshaft and/or the drive, in particular the drive shaft, and/or the drive output.

Further connection possibilities for further housing modules can be provided on the housing wall of the first and/or the second and/or the third and/or the fourth housing module in order, for example, to be able to connect the first and/or the second differential or the first power output to the layshaft and/or drive and/or drive output extending through the input-side and/or output-side housing walls.

The first and the second and/or the third and/or the fourth housing modules can be disposed along a longitudinal axis of the transmission housing assembly, and in particular along a longitudinal axis of the working machine. The longitudinal axis of the transmission housing assembly and a longitudinal axis of the working machine and/or the drive can be identical or parallel.

The transmission housing assembly can thus advantageously be of modular construction. In this context, modular is understood to mean that the transmission housing assembly is composed of a plurality of housing modules, and a housing module is formed for each of the transmission units described above, said housing module constituting the entire transmission housing assembly when assembled with the other housing modules. The adjacent and/or mutually contiguous housing walls can presently be designed as separate or common housing walls. Such an arrangement makes it possible for the transmission units to be changed easily and cost-effectively without having to completely disassemble the entire drive device. Here, the advantages of a transmission housing assembly and/or drive device become evident with regard to lower assembly outlay, high degree of compatibility and variability. Furthermore, as a result of the transmission housing assembly, the drive device can advantageously be disposed in a modular manner and/or be of a modular construction.

The disclosure furthermore relates to a working machine having a drive device, in particular a drive device according to one or more embodiments disclosed herein, or a transmission housing assembly, in particular a transmission housing assembly according to one or more embodiments disclosed herein. The working machine can be a construction machine or a towing vehicle, preferably an agricultural towing vehicle, for example a tractor or hauler. The working machine has the above-described advantages of the drive device and/or of the transmission housing assembly.

The working machine comprises the drive device or the transmission housing assembly. The drive device is designed for driving the working machine. The working machine can comprise one, two or a plurality of axle(s). The working machine can be able to be driven by a rotating speed and/or force and/or torque of the motor.

The control unit can be specified for controlling in an open loop and/or a closed loop, in particular for setting and/or adjusting, the working machine, in particular the motor. The working machine can comprise an input and output unit. The control unit can be connected to the input and output unit for signaling, and/or operatively coupled and/or connected thereto for transmitting signals and/or transmitting data, and/or can be able to be actuated and/or set and/or adjusted by the input and output unit. The input and output unit can be integrated into the control unit, or vice versa. The operator of the working machine can use the input and output unit to set and/or adjust a speed of the working machine, for example.

The working machine can moreover comprise one or more auxiliary units, for example a pump and/or a radiator, etc. The auxiliary units can be part of the hydraulic system of the drive device. The working machine can comprise the first power output, in particular the PTO unit. The control unit can be configured to set and/or adjust and/or actuate the drive device and/or the axle and/or working machine by a travel signal and to set and/or adjust, in particular to increase or reduce, a speed of the working machine by or based on the travel signal. The working machine can comprise the one or more ground-engaging means. The ground-engaging means can support and/or carry the working machine on the ground. A towing vehicle frame of the working machine, in particular a first and a second frame element, can be supported on the ground-engaging means. The ground-engaging means can be wheels or tracks or chains. In particular, the ground-engaging means can be front wheels and rear wheels. The working machine can comprise a speed sensor, for example a rotating speed sensor, for detecting a speed of the working machine. Specifically, the control unit can be configured to set and/or adjust and/or actuate a force and/or a torque and/or a rotating speed of the motor and/or of the first and/or the second variator by the travel signal.

In a design embodiment of the disclosure, the working machine comprises two frame elements, in particular a first and a second frame element. The drive device, preferably the transmission housing assembly, particularly preferably the first and/or second and/or third and/or fourth housing module, is/are disposed on, in particular between, the frame elements. The frame elements, in particular the first and the second frame element, can be disposed parallel to the longitudinal axis of the working machine. The transmission housing assembly, in particular the first and the second and/or the third and/or the fourth housing module, can be disposed along the longitudinal axis of the working machine. The longitudinal axis of the transmission housing assembly and the longitudinal axis of the working machine can be identical or parallel. The first and/or second and/or third and/or fourth housing module can be disposed between the frame elements, in particular also be fastened thereto and/or mounted thereon. Likewise, the PTO unit can be disposed on the frame elements, in particular be fastened thereto and/or mounted thereon.

The shifting elements, in particular their valves or valve assemblies or actuators, and/or the motor and/or the first power output, in particular the PTO unit, and/or the first and/or the second variator and/or the energy store and/or the power electronics unit can be able to be actuated and/or set and/or adjusted, preferably able to be controlled in an open loop and/or closed loop, by the control unit. The control unit can send and/or receive signals to control the operation of the drive device and/or of the working machine. The signals can be expediently provided via a suitable data communication network, for example one which conforms to the ISOBUS and/or CAN standard. The control unit can be designed as an electronic module, an embedded system, a computing unit, a computer, as a module for controlling in an open and/or closed loop the drive device and/or the working machine. The control unit can comprise one or a plurality of processors, a memory and/or all of the software, hardware, algorithms, connections, and in particular also sensors, that are required for the open-loop and/or closed-loop control of the drive device and/or the working machine. Methods can take the form of a program or algorithm which is able to be executed on and/or by the control unit. The control unit can comprise any apparatus that analyses data from various sensors, compares data, and makes the decisions necessary to control in an open loop and/or a closed loop and/or to carry out the operation of the drive device and/or the working machine, and the necessary tasks for controlling in an open loop and/or closed loop the operation of the drive device and/or the working machine. The control unit can be connected for signalling and/or operatively coupled and/or connected for transmitting signals and/or transmitting data to the components of the drive device and/or the working machine, thus in particular to the first power output and/or the motor and/or the first and/or the second variator and/or the sensors, for example the speed sensor, and/or the energy store and/or the power electronics unit and/or the rotating speed and/or torque sensor(s). Connected for signaling and/or operatively coupled and/or connected for transmitting signals and/or transmitting data is presently understood to mean, inter alia, that signals and/or data can be exchanged between the connected components and the control unit. Signals can, for example, be received and sent, and/or processed and/or manipulated, by the control unit. The connection between the control unit as well as the parts or components of the drive device and/or the working machine can be implemented by wire, i.e. in particular by cables, and/or in a wireless manner, i.e. by radio, for example by Bluetooth or WLAN. Communication can take place, for example, by Isobus, CAN bus, or the like. The control unit can be connected directly to the input and output unit, in particular to the input and output unit which is disposed in a cab of the working machine and by which data entered by an operator can be transmitted to the control unit, or data can be received from the control unit and output to the latter. The control unit can be integrated into the input and output unit, or vice versa.

Other features and aspects will become apparent by consideration of the detailed description, claims, and accompanying drawings.

### BRIEF DESCRIPTION OF THE DRAWINGS

The disclosure and further advantages and advantageous refinements and design embodiments of the disclosure, both in terms of hardware and in terms of method, will be explained in more detail below on the basis of example embodiments and with reference to the drawing. Components with an equivalent or comparable function herein are identified by the same reference signs.

FIG. 1 shows a schematic illustration of a first example embodiment of a working machine according to the disclosure, having a drive device according to the disclosure.

FIG. 2 shows a schematic illustration of a first example embodiment of the drive device according to the disclosure.

FIG. 3 shows a schematic illustration of a second example embodiment of the drive device according to the disclosure.

FIG. 4 shows a schematic illustration of a third example embodiment of the drive device according to the disclosure.

FIG. 5 shows a schematic illustration of a fourth example embodiment of the drive device according to the disclosure.

FIG. 6 shows a schematic illustration of a fifth example embodiment of the drive device according to the disclosure.

FIG. 7 shows a schematic illustration of a sixth example embodiment of the drive device according to the disclosure.

FIG. 8 shows a schematic illustration of a seventh example embodiment of the drive device according to the disclosure.

FIG. 9 shows a schematic illustration of an eighth example embodiment of the drive device according to the disclosure.

FIG. 10 shows a schematic illustration of a ninth example embodiment of the drive device according to the disclosure.

FIG. 11 shows a schematic illustration of an example embodiment of the first transmission unit.

FIG. 12 shows a schematic illustration of a further example embodiment of the first transmission unit.

FIG. 13 shows a schematic illustration of an example embodiment of the third transmission unit.

FIG. 14 shows a schematic illustration an example embodiment of the fourth transmission unit.

FIG. 15 shows a schematic illustration an example embodiment of the second transmission unit.

FIG. 16 shows a schematic illustration of a further example embodiment of the second transmission unit.

FIG. 17 shows a schematic illustration of a first example embodiment of a transmission housing assembly according to the disclosure.

FIG. 18 shows a schematic illustration of a second example embodiment of a transmission housing assembly according to the disclosure.

FIG. 19 shows a schematic illustration of a third example embodiment of a transmission housing assembly according to the disclosure.

FIG. 20 shows a schematic illustration of a further example embodiment of a working machine according to the disclosure, having a transmission housing assembly according to the disclosure and a drive device.

Like reference numerals are used to indicate like elements throughout the several figures.

### DETAILED DESCRIPTION

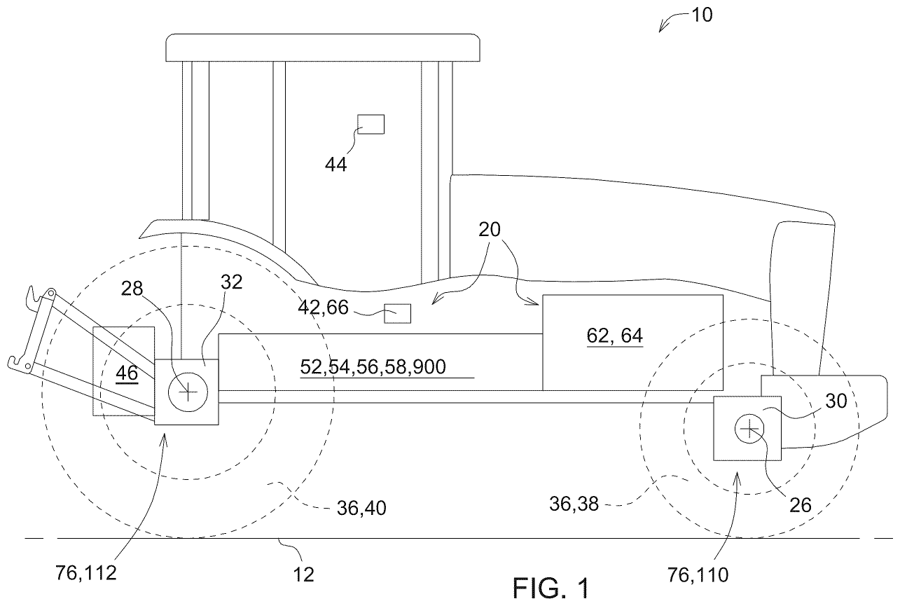

FIG. 1 shows a schematic illustration of a first example embodiment of a working machine 10 according to the disclosure, presently an agricultural towing vehicle or tractor or hauler, having a drive device 20 according to the disclosure. The working machine 10 is able to be driven by the drive device 20.

The drive device 20 comprises a drive 52, which can be designed in particular as a drive shaft 50, and a drive output 54, which can be designed in particular as a drive output shaft 60, and a first and a second transmission unit 56, 58. The working machine 10, in particular the drive device 20, comprises a first vehicle axle 26 and a second vehicle axle 28. The first vehicle axle 26 can be a front axle, and the second vehicle axle 28 can be a rear axle. Moreover, the first vehicle axle 26 can be embodied as a steerable axle. The working machine 10 can have one or a plurality of ground-engaging means 36, presently illustrated in the form of wheels 38, 40, which engage with a ground 12 in order to transmit drive forces and/or by which the working machine 10 is supported on the ground 12. The working machine 10, in particular the drive device 20, can comprise a propulsion drive 76, in particular a front-axle drive 110 and a rear-axle drive 112. The propulsion drive 76 can comprise the first vehicle axle 26 and/or the second vehicle axle 28 and/or a first differential 30 and/or a second differential 32 and/or the one or more ground-engaging means 36. The working machine 10, in particular the drive device 20, can have a front-axle drive 110 which can comprise the first vehicle axle 26 and/or the first differential 30, thus in particular a front-axle differential, and/or the one or more ground engagement means 36. Likewise, the working machine 10, or in particular the drive device 20, can have a rear-axle drive 112 which can comprise the second vehicle axle 28 and/or the second differential 32, thus in particular a rear-axle differential, and/or the one or more ground-engaging means 36. The first vehicle axle 26 can be connected to the first differential 30. The second vehicle axle 28 can be connected to the second differential 32.

The drive output 54 can be connected to the propulsion drive 76, in particular to the first and/or the second differential 30, 32, in particular only to the second differential 32. The drive output 54 can be connected to the second vehicle axle 28 by way of the second, or with the second, differential 32. A force and/or a torque and/or a rotating speed can be transmittable from the drive output 54 to the first and/or the second vehicle axle 26, 28, and thus in particular to the ground-engaging means 36, by way of the first, or with the first, differential 30 and/or by way of the second, or with the second, differential 32.

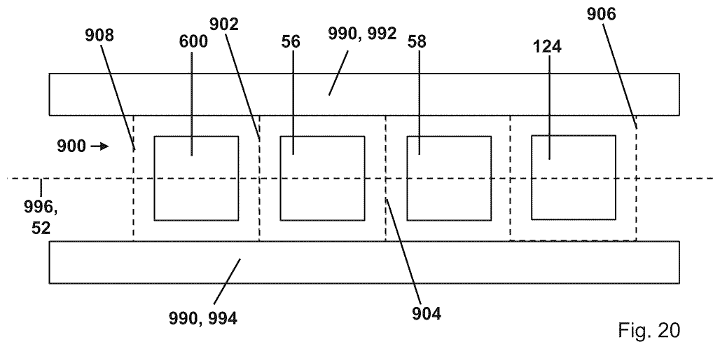

The drive device 20 or the working machine 10 can comprise a motor 62. The motor 62 can be connectable, or connected, to the drive 52. With the drive device 20, in particular the motor 62, a rotating movement and/or force and/or a torque and/or a rotating speed can be generatable and can be transmittable to the drive output 54, to the first and/or the second vehicle axle 26, 28, in particular by way of the first and/or a second transmission unit 56, 58. The first and/or the second vehicle axle 26, 28 convert the rotating movement and/or force and/or the torque and/or the rotating speed into a rotating movement and/or force and/or a torque and/or rotating speed of one or a plurality of ground-engaging means 36, and thus into thrust of the working machine 10. Moreover, the working machine 10 can comprise a towing vehicle frame which can have, in particular, a first and a second frame element 960, 962, 964 (see FIG. 20). The towing vehicle frame can in particular be supported by ground engagement means 36, in particular the wheels 38, 40, which are suspended on the first and/or the second vehicle axle 28, 30. Specifically, a first pair of wheels 38 are disposed on the first vehicle axle 26, and a second pair of wheels 40 are disposed on the second vehicle axle 28. Here, the diameters of the wheels 38, 40 may differ; in particular, the diameter of the first pair of wheels 38 may be smaller than the diameter of the second pair of wheels 40. Alternatively, the ground-engaging means 36 can also be designed and disposed as tracks or chains.

The working machine 10, in particular the drive device 20, can comprise a first power output 46. The first power output 46 can comprise a PTO unit 90. The first power output 46 can be provided for driving an implement (not shown) which is able to be attached to the working machine 10 by way of an interface (e.g. three-point interface).

The working machine 10, in particular alternatively or additionally the drive device 20, can comprise a control unit 42 and/or an input and output unit 44. The control unit 42 can be connected to the input and output unit 44 for signaling, and/or be operatively coupled thereto and/or connected thereto for transmitting signals and/or transmitting data. Specifically, the control unit 42 can be connected directly to the input and output unit 44 which is disposed in a cab of the working machine 10, and by way of which data entered by an operator can be transmitted to the control unit 42 or received and outputted by the latter. The drive device 20, and/or in particular the working machine 10, can be able to be set and/or adjusted by the control unit 42. The control unit 42 is connected to the motor 62 for signaling, and/or is operatively coupled and/or connected thereto for transmitting signals and/or transmitting data. The control unit 42 is configured to set and/or adjust the rotating speed and/or the torque and/or the force of the drive device 20, in particular of the motor 62, in particular to actuate and/or control the latter in an open loop and/or closed loop.

The control unit 42 can be configured to set and/or adjust a predefinable rotating speed and/or a predefinable torque and/or a predefinable force of the drive device 20, in particular of the motor 62, in particular to actuate and/or control the latter in an open loop and/or closed loop. The control unit 42 can be configured to set and/or adjust the drive device 20, in particular alternatively or additionally the working machine 10, in order to set and/or to adjust, in particular to control in an open loop and/or closed loop, the rotating speed and/or the torque and/or the force of the motor 62.

Moreover, alternatively or additionally, the working machine 10 can comprise the drive device 20, a power electronics unit 66 in order to transmit the electrical power or energy between the first and/or the second variator 70, 74, in particular when the latter are designed as a first and/or a second electric motor 500, 502, and an energy store 64. The energy store 64 can supply the electrically driven components of the drive device 20, preferably the first and/or the second electric motor 500, 502, with currents or voltages of suitable frequency and amplitudes in order to provide desired output rotating speeds or torques for the first power output 46 and/or the drive device 20.

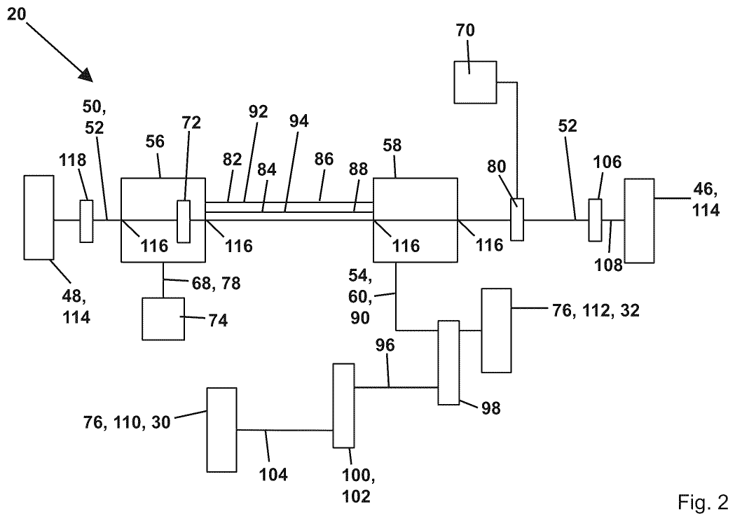

FIG. 2 shows a schematic illustration of a first example embodiment of the drive device 20 according to the disclosure. The drive device 20 shown in FIG. 2 corresponds substantially to the drive device 20 in FIG. 1, and therefore only details and/or points of differentiation will be discussed below. The working machine 10 illustrated in FIG. 1 can comprise the drive device 20 illustrated in FIG. 2.

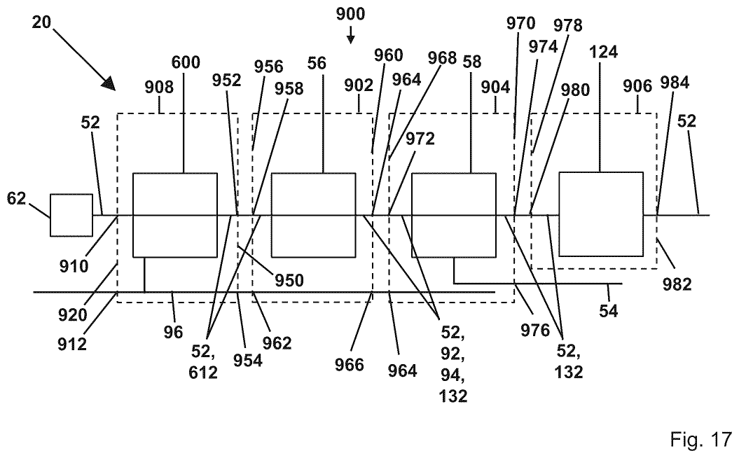

The drive device 20 for a working machine 10 or a transmission housing assembly 900 (see FIGS. 17-20) according to FIG. 2 comprises a drive 52, which can be designed in particular as a drive shaft 50, and a drive output 54, which can be designed in particular as a drive output shaft 60. Furthermore, the drive device 20 comprises a first and a second variator 70, 74. The first variator 70 can be designed as a first electric motor 500, and the second variator 74 can be designed as a second electric motor 502. However, the first and the second variator 70, 74 can also be designed as a hydrostat, in particular a hydraulic pump and a hydraulic motor.

The drive device 20 moreover comprises the first transmission unit 56, wherein the first transmission unit 56 is designed as a planetary coupling transmission 300 with a first and a second input side 72, 78 and a first and a second output side 82, 84. The first transmission unit 56, in particular the planetary coupling transmission 300, can have two different stationary transmission ratios.

The first variator 70 is connectable, or connected, to the drive 52, in particular the drive shaft 50, in particular by way of a, or by a, first transmission stage 80. Moreover, the first variator 70 is connectable, or connected, to the first transmission unit 56, preferably to the first input side 72, by way of the, or by the, drive 52, in particular the drive shaft 50. The first input side 72 can be connected to a first input shaft 132. The second variator 74 is connectable, or connected, to the second input side 78, in particular by way of a, or by a, second transmission stage 68. The second input side 78 can be connected to a second input shaft 612.

The drive device 20 furthermore comprises a second transmission unit 58 with a third and a fourth input side 86, 88 and at least one third output side 90. The second transmission unit 58 can comprise a first spur gear stage 306 and/or a second spur gear stage 314 and/or a third planetary transmission 614 and at least one first and one second shifting element 308, 310. The first output side 82 is connectable, or connected, to the third input side 86, and/or the second output side 84 is connectable, or connected, to the fourth input side 88. The first output side 82 and the third input side 86 can be designed as a third input shaft 92. Specifically, the first output side 82 and the third input side 86 are connected by way of, or by, the third input shaft 92. The second output side 84 and the fourth input side 88 can be designed as a fourth input shaft 94. Specifically, the first output side 82 and the third input side 86 are connected by way of, or by, the fourth input shaft 94. The second transmission unit 58, in particular the third output side 90, is connectable, or connected, to the drive output 54, in particular the drive output shaft 60. The drive output 54 can moreover be connectable, or connected, to the propulsion drive 76, preferably to the rear-axle drive 112, particularly preferably to the second differential 32. Likewise, the drive output 54 can be connectable, or connected, to a layshaft 96, in particular by way of a, or by a, third transmission stage 98.

Moreover, the layshaft 96 can be connectable, or connected, to the propulsion drive 76, preferably the front-axle drive 110, particularly preferably the first differential 30. The layshaft 96 can be connectable, or connected, to a further shaft 104 with a fourth, or by way of a fourth, transmission stage 100, for example a sixth spur gear stage, or a pair of gearwheels, or three or more gearwheels, or a sixth planetary transmission or any other transmission, and/or a further shifting element 102.

The drive device 20 can moreover comprise the first power output 46. The first variator 70 can be connectable, or connected, to the first power output 46. Specifically, the first variator 70 can be connectable, or connected, to the first power output 46 by way of the, or by the, drive 52. The drive 52 can be connectable, or connected, to the first power output 46 with a ninth, or by a ninth, shifting element 106. The ninth shifting element 106 can be connectable, or connected, to the first power output 46 by a or with a connecting shaft 108. The first power output 46 can comprise a PTO unit 114. The PTO unit 114 can comprise a PTO gear and/or a PTO shaft. The ninth shifting element 106 and/or the PTO unit 114, in particular the PTO gear, can on the drive side be connected to the drive 52. Moreover, the PTO unit 114, in particular the PTO gear, can on the drive output side be connectable, or connected, to the PTO shaft. The first and/or the second transmission unit 56, 58 can furthermore have a conduit 116, in particular a central conduit, for the drive 52, thus in particular the drive shaft 60.

The drive device 20 can moreover comprise a second power output 48. The first variator 70 can be connectable, or connected, to a second power output 48. Specifically, the first variator 70 can be connectable, or connected, to the second power output 48 by way of the, or by the, drive 52. The first variator 70 can be connected to a tenth shifting element 118 by way of the drive 52. The first variator 70 can be connectable to the second power output 48 by the tenth shifting element 118. The second power output 48 can comprise a PTO unit 114. The PTO unit 114 can comprise a PTO gear and/or a PTO shaft. FIGS. 2-5 schematically describe the power flux of the drive device 20 to the drive 54.

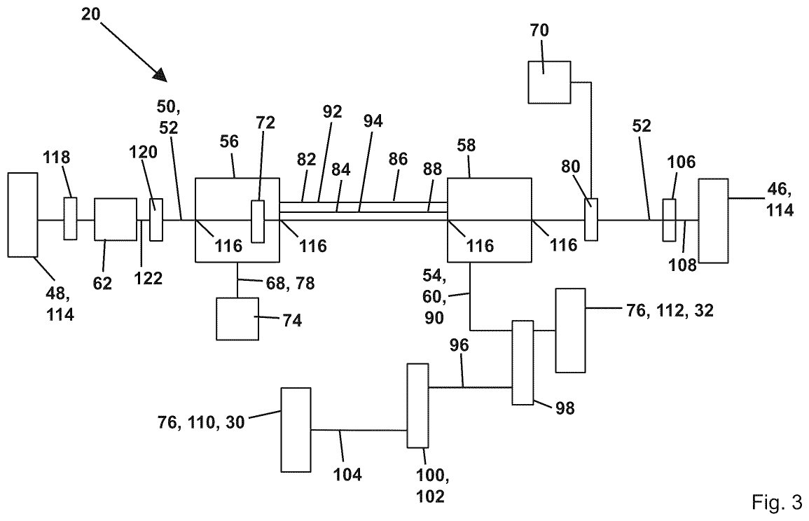

FIG. 3 shows a schematic illustration of the second example embodiment of the drive device 20 according to the disclosure. The drive device 20 shown in FIG. 3 corresponds substantially to the drive device 20 shown in FIGS. 1 and 2, and therefore only details and/or points of differentiation will be discussed below. The working machine 10 illustrated in FIG. 1 can comprise the drive device 20 illustrated in FIG. 3.

The drive device 20 can furthermore comprise a motor 62. The motor 62 is connected to the first input side 72 by way of the, or by the, drive 52, and in particular connected to the first variator 70 by way of the first transmission stage 80. The motor 62 can be connectable, or connected, to the drive 52, in particular by way of an eighth, or with an eighth, shifting element 120. A rotating speed and/or a torque and/or a force can thus be able to be directed into the first transmission unit 56 by the motor 62. The first transmission unit 56 can be disposed ahead of the second transmission unit 58 in the torque and/or power flux. The motor 62 can moreover be connectable, or connected, to the first and/or the second power output 46, 48. Specifically, the motor 62 and/or the first variator 70 can be connectable, or connected, to the first power output 46 by way of the, or by the, drive 52. The motor 62 herein can be connected to the eighth shifting element 120 with a connecting shaft 122. The motor 62 herein can be connectable to the drive 52 by the, or by way of the, eighth shifting element 120. The motor 62 can be connected to the tenth shifting element 118 by way of the drive 52. The motor 62 can be connectable to the second power output 48 by the tenth shifting element 118.

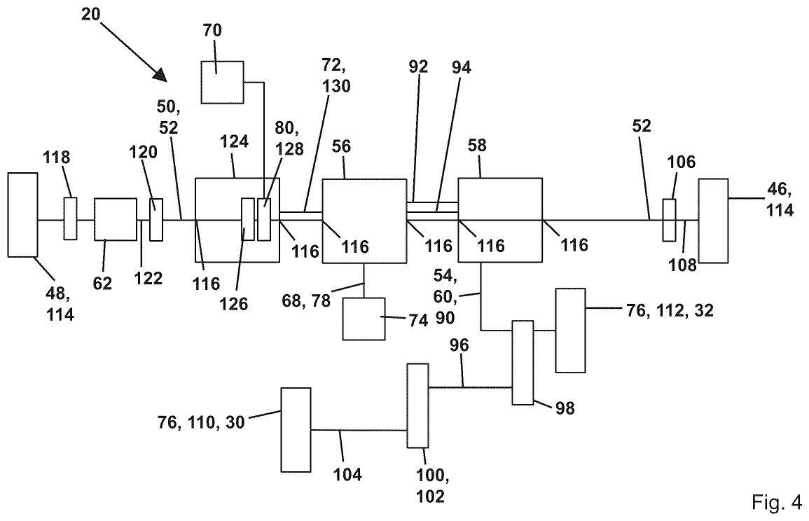

FIG. 4 shows a schematic illustration of the third example embodiment of the drive device 20 according to the disclosure. The drive device 20 shown in FIG. 4 corresponds substantially to the drive device 20 shown in FIGS. 1-3, and therefore only details and/or points of differentiation will be discussed below. The working machine 10 illustrated in FIG. 1 can comprise the drive device 20 illustrated in FIG. 4.

The drive device 20 comprises a third transmission unit 124 which can in particular be a reversing unit or a powershift reversing unit. The third transmission unit can be designed to reverse the direction of rotation of the drive output 54. The third transmission unit 124 is on the input side connectable, or connected, to the first transmission unit 56. The third transmission unit 124 is on the output side connectable, or connected, to the second transmission unit 58. The third transmission unit 124 has a fifth and a sixth input side 126, 128 and a fifth output side 130. The third transmission unit 124 is on the input side connectable, or connected, to the drive 52. Additionally, the third transmission unit 124 can be connectable, or connected, to the first variator 70, in particular by way of the first transmission stage 80. The third transmission unit is on the output side connectable, or connected, to the first transmission unit 56, in particular to the first input side 72. Specifically, the drive 52 is connectable, or connected, to the fifth input side 126, and by way of the first transmission stage 80 to the sixth input side 128. The fifth output side 130 is connectable, or connected, to the first input side 72 by way of the first input shaft 132.

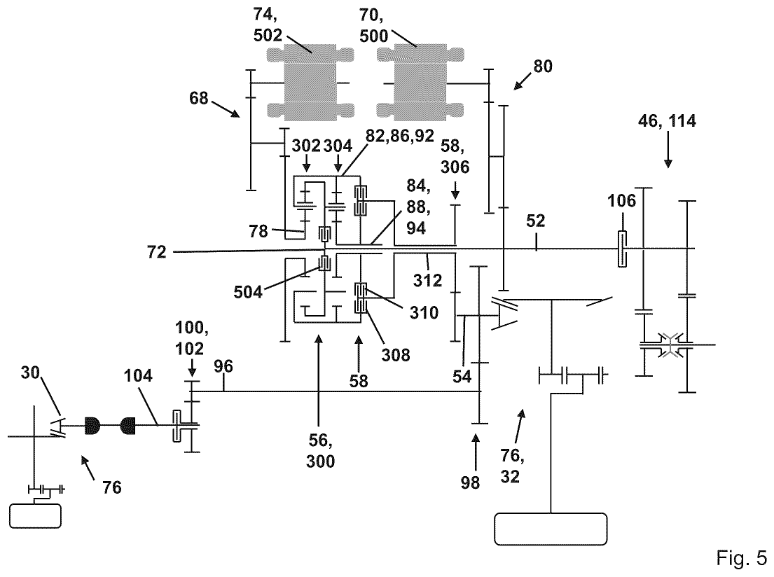

FIG. 5 shows a schematic illustration of the fourth example embodiment of the drive device 20 according to the disclosure. The drive device 20 shown in FIG. 5 corresponds substantially to the drive device 20 shown in FIGS. 1-4, and therefore only details and/or points of differentiation will be discussed below. The working machine 10 illustrated in FIG. 1 can comprise the drive device 20 illustrated in FIG. 5.

The drive device 20 according to FIG. 5 comprises the drive 52 and the drive output 54 and the first and the second variator 70, 74, the latter being designed as the first and the second electric motor 500, 502, but does not comprise any motor 62. Moreover, the drive device 20 comprises the first and the second transmission unit 56, 58. The first variator 70, in particular by way of the first transmission stage 80 which presently is designed as two respectively engaged pairs of gearwheels, is connectable to the drive 52, and by way of the, or by the, drive 52 and a seventh shifting element 504 connectable to the first input side 72 of the first transmission unit 56. The second variator 74 is connected to the second input side 78, in particular by way of a, or by the, second transmission stage 68. The second input side 78 can be connected to the second input shaft 612.

The first transmission unit 56 is designed as a planetary coupling transmission 300 (see FIG. 3), in particular with two different stationary transmission ratios. Specifically, the first transmission unit 56 can comprise a first and/or a second planetary transmission 302, 304, wherein the first and the second planetary transmission 302, 304 are coupled to one another. The first transmission unit 56 thus has 4 degrees of freedom.

The second transmission unit 58 comprises the first spur gear stage 306 and the first and the second shifting element 308, 310. The first output side 82 of the first transmission unit 56 is connected to the third input side 86 of the second transmission unit 58, in particular to the third input shaft 92. The second output side 84 of the first transmission unit 56 is connected to the fourth input side 88 of the second transmission unit 58, in particular to the fourth input shaft 94. As a result, force and/or torque and/or rotating speed can be transmittable from the first to the second transmission unit 56, 58. The second transmission unit 58 is disposed downstream of the first transmission unit 56 in the torque and/or power flux. The second transmission unit 58, in particular the third output side 90, is connected to the drive output 54, in particular to the drive output shaft 60. The first and the second shifting element 308, 310 are connected to the first spur gear stage 306 by way of a further shaft 312. The first output side 82 and/or the third input side 86 can be connectable, or connected, to the first spur gear stage 306 by the, or by way of the, first shifting element 308, and/or the second output side 84 and/or the fourth input side 88 can be connectable, or connected, to the first spur gear stage 306 by the, or by way of the, second shifting element 310.

The drive device 20 moreover comprises the first power output 46. The first variator 70, in particular the first electric motor 500, can be connectable, or connected, to the first power output 46 by way of the drive 52, and the ninth shifting element 106 can be connectable, or connected, to the first power output 46. The first power output 46 comprises the PTO unit 114. The first and/or the second transmission unit 56, 58 moreover have conduits 116, in particular central conduits, for the drive 52.

The drive output 54 is connected to the layshaft 96, in particular by way of the third transmission stage 98 which is presently designed as a spur gear stage. The drive output 54 can moreover be connected to the propulsion drive 76, in particular to the second differential 32. The layshaft 96 is connected to the propulsion drive 76, in particular to the first differential 30, by way of the fourth transmission stage 100 and the further shifting element 102. The layshaft 96 and the drive output 54 are disposed so as to be mutually coaxial.

With the drive device 20 according to FIG. 5, the in each case six modes per direction of rotation of the drive output 54, or in other words in the forward and reverse directions of the working machine 10, can advantageously be implemented.

With the fourth embodiment according to FIG. 5, six modes per direction of rotation of the drive output 54 of the drive device 20, or in other words in the forward and reverse directions of the drive device 20 or working machine 10, can in each case be implemented with the first and the second transmission unit 56, 58 (see Table 1). Specifically, six forward and six reverse gears of the drive device 20 or working machine 10 can be implemented.

TABLE 1
Modes of the fourth embodiment

| Forward | Reverse | | | | | | |
|---|---|---|---|---|---|---|---|
| Mode | mode | 504 | 308 | 310 | 106 | 74, 502 | 70, 500 |
| Mode 1 | | | X | X | | Propulsion drive | — |
| Mode 2 | | | X | X | X | Propulsion drive | First power |
| | | | | | | | output |
| Mode 3 | | X | X | | | Propulsion drive | Propulsion drive |
| Mode 4 | | X | | X | | Propulsion drive | Propulsion drive |
| Mode 5 | | X | X | | X | First power | First power |
| | | | | | | output & | output & |
| | | | | | | propulsion drive | propulsion drive |
| Mode 6 | | X | | X | X | First power | First power |
| | | | | | | output & | output & |
| | | | | | | propulsion drive | propulsion drive |
| | Mode 1 | | X | X | | Propulsion drive | — |
| | Mode 2 | | X | X | X | Propulsion drive | First power |
| | | | | | | | output |
| | Mode 3 | X | X | | | Propulsion drive | Propulsion drive |
| | Mode 4 | X | | X | | Propulsion drive | Propulsion drive |
| | Mode 5 | | X | | X | First power | First power |
| | | | | | | output & | output & |
| | | | | | | propulsion drive | propulsion drive |
| | Mode 6 | X | | X | X | First power | First power |
| | | | | | | output & | output & |
| | | | | | | propulsion drive | propulsion drive |

The modes can be implemented by opening and closing the shifting elements associated with the reference signs mentioned and by operating the variators as illustrated in Table 1. Specifically, the modes can be implemented by opening and closing the seventh shifting element 504 and/or the first shifting element 308 and/or the second shifting element 310 and/or the ninth shifting element 106, and by operating the first and the second variator 70, 74, the latter being designed as the first and the second electric motor 500, 502, as illustrated in Table 1.

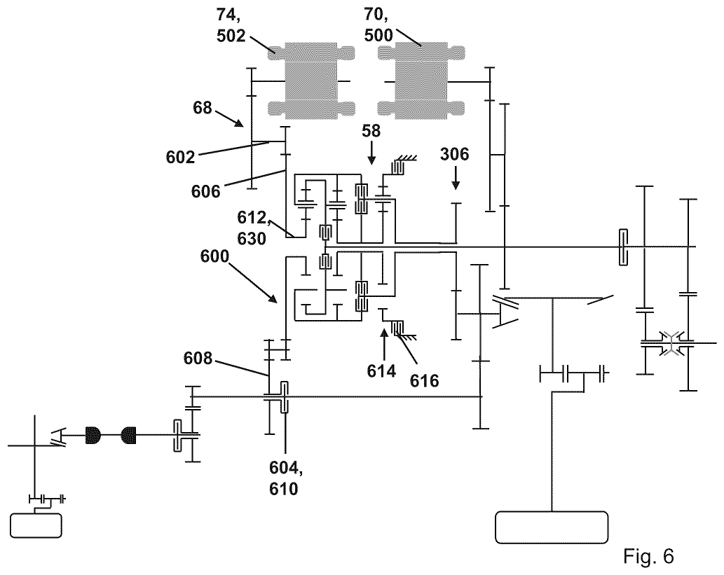

FIG. 6 shows a schematic illustration of the fifth example embodiment of the drive device 20 according to the disclosure. The drive device 20 shown in FIG. 6 corresponds substantially to the drive device 20 shown in FIGS. 1-5, and therefore only details and/or points of differentiation will be discussed below. The working machine 10 illustrated in FIG. 1 can comprise the drive device 20 illustrated in FIG. 6.

The drive device 20 additionally comprises the fourth transmission unit 600. The fourth transmission unit 600 has a seventh input side 602 and at least one sixth output side 604. The fourth transmission unit 600 is connectable to the layshaft 96. The fourth transmission unit comprises a third and a fourth spur gear stage 606, 608 and a sixth shifting element 610. The second variator 74 is connected to the third spur gear stage 606 by way of, or by, the second transmission stage 68 and a further shaft. The third spur gear stage 606 is connected to the fourth spur gear stage 608 by way of a further shaft. Moreover, the third spur gear stage 606, as a seventh output side 630, is connected to the first transmission unit 56, in particular to the second input side 78, presently a second input shaft 612. The fourth spur gear stage 608 is connectable to the layshaft 96 by way of the, or by the, sixth shifting element 610.

Moreover, the second transmission unit 58 comprises the first spur gear stage 306 and the third planetary transmission 614, and the first and the second and the third shifting element 308, 310, 616.

With the fifth embodiment according to FIG. 6, ten modes per direction of rotation of the drive output 54 of the drive device 20, or in other words in the forward and reverse directions of the drive device 20 or working machine 10, can in each case be implemented with the first and the second transmission unit 56, 58 and the fourth transmission unit 600 (see Table 2). Specifically, ten forward and ten reverse gears of the drive device 20 or working machine 10 can be implemented.

TABLE 2
Modes of the fifth embodiment

| Forward | Reverse | | | | | | | | |
|---|---|---|---|---|---|---|---|---|---|
| Mode | mode | 504 | 308 | 310 | 610 | 616 | 106 | 74, 502 | 70, 500 |
| Mode 1 | | | | | X | | | Propulsion drive | — |
| Mode 2 | | | X | X | | | | Propulsion drive | — |
| Mode 3 | | | | | X | | X | Propulsion drive | First power output |
| Mode 4 | | | X | X | | | X | Propulsion drive | First power output |
| Mode 5 | | X | | X | | X | | Propulsion drive | Propulsion drive |
| Mode 6 | | X | X | | | | | Propulsion drive | Propulsion drive |
| Mode 7 | | | | X | | | | Propulsion drive | Propulsion drive |
| Mode 8 | | X | | X | | X | X | First power output & | First power output & |
| | | | | | | | | propulsion drive | propulsion drive |
| Mode 9 | | X | X | | | | X | First power output & | First power output & |
| | | | | | | | | propulsion drive | propulsion drive |
| Mode 10 | | X | | X | | | X | First power output & | First power output & |
| | | | | | | | | propulsion drive | propulsion drive |
| | Mode 1 | | | | X | | | Propulsion drive | — |
| | Mode 2 | | X | X | | | | Propulsion drive | — |
| | Mode 3 | | | | X | | X | Propulsion drive | First power output |
| | Mode 4 | | X | X | | | X | Propulsion drive | First power output |
| | Mode 5 | X | | X | | X | | Propulsion drive | Propulsion drive |
| | Mode 6 | X | X | | | | | Propulsion drive | Propulsion drive |
| | Mode 7 | X | | X | | | | Propulsion drive | Propulsion drive |
| | Mode 8 | X | | | | X | X | First power output & | First power output & |
| | | | | | | | | propulsion drive | propulsion drive |
| | Mode 9 | X | X | | | | X | First power output & | First power output & |
| | | | | | | | | propulsion drive | propulsion drive |
| | Mode 10 | X | | X | | | X | First power output & | First power output & |
| | | | | | | | | propulsion drive | propulsion drive |

The modes can be implemented by opening and closing the shifting elements associated with the reference signs mentioned and by operating the variators as illustrated in Table 2. Specifically, the modes can be implemented by opening and closing the seventh shifting element 504 and/or the first shifting element 308 and/or the second shifting element 310 and/or the third shifting element 616 and/or the sixth shifting element 610 and/or the ninth shifting element 106 and by operating the first and the second variator 70, 74, the latter being designed as the first and the second electric motor 500, 502, as illustrated in Table 2.

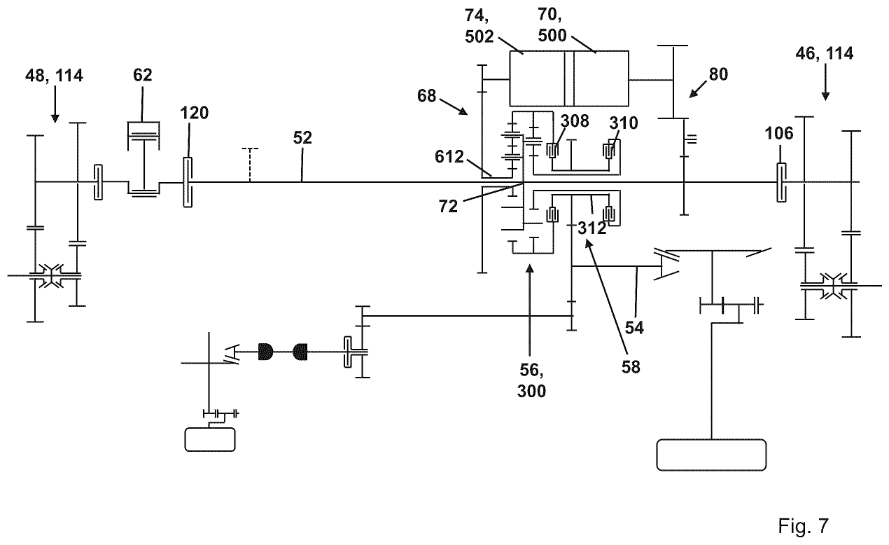

FIG. 7 shows a schematic illustration of the sixth example embodiment of the drive device 20 according to the disclosure. The drive device 20 shown in FIG. 7 corresponds substantially to the drive device 20 shown in FIGS. 1 to 6, and therefore only details and/or points of differentiation will be discussed below. The working machine 10 illustrated in FIG. 1 can comprise the drive device 20 illustrated in FIG. 7.

The drive device 20 comprises the first and the second transmission unit 56, 58, wherein the first transmission unit is illustrated as a planetary coupling transmission 300 in a further embodiment. Moreover, the drive device 20 according to FIG. 7 comprises the motor 62. The motor 62 is connected to the first input side 72 and to the first variator 70 by way of the, or by the, drive 52. Here, the drive 52 is connected to the first variator 70 by way of the first transmission stage 80 which is presently designed as three engaged gearwheels with a freely rotating gearwheel. Moreover, the motor 62 is connectable to the first power output 46, in particular the PTO unit 114, with the ninth, or by the ninth, shifting element 106. The second variator 74 is connected to the first transmission unit 56, in particular the second input side 78, presently the second input shaft 612, by way of the second transmission stage 68.

With the sixth embodiment according to FIG. 7, two modes in a direction of rotation of the drive output 54 of the drive device 20, or in other words in the forward direction of the drive device 20 or working machine 10, can be implemented with the first and the second transmission unit 56, 58 (see Table 3). Specifically, two forward gears of the drive device 20 or working machine 10 can be implemented.

TABLE 3
Modes of the sixth embodiment.

| Forward | Reverse | | |
|---|---|---|---|
| Mode | mode | 308 | 310 |
| Mode 1 | | | X |
| Mode 2 | | X | |

The modes can be implemented by opening and closing the shifting elements associated with the reference signs mentioned and by operating the variators as illustrated in Table 3. Specifically, the modes can be implemented by opening and closing the first shifting element 308 and/or the second shifting element 310 as illustrated in Table 3.

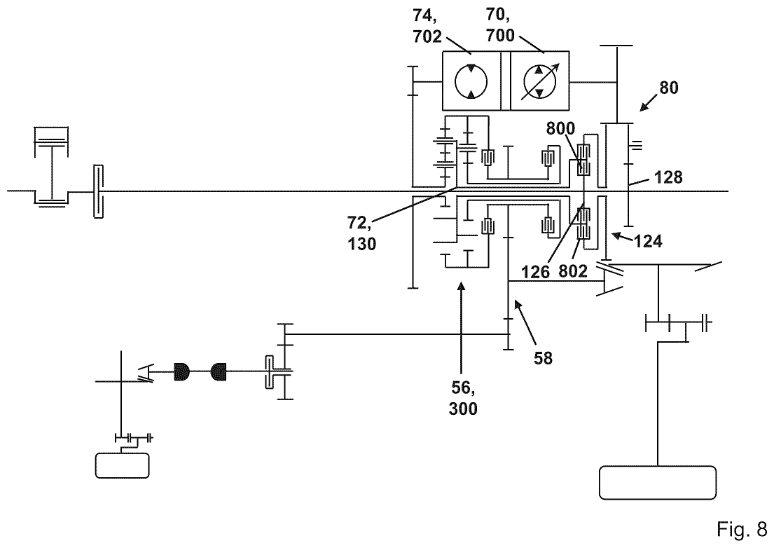

FIG. 8 shows a schematic illustration of the seventh example embodiment of the drive device 20 according to the disclosure. The drive device 20 shown in FIG. 8 corresponds substantially to the drive device 20 shown in FIGS. 1-7, and therefore only details and/or points of differentiation will be discussed below. The working machine 10 illustrated in FIG. 1 can comprise the drive device 20 illustrated in FIG. 8.

The drive device 20 comprises the first and the second and the third transmission unit 56, 58, 124. The first and the second variator 70, 74 are designed as a hydrostat. Presently, the first variator 70 is designed and/or operable as a hydraulic pump 700, and the second variator 74 is designed and/or operable as a hydraulic motor 702. The third transmission unit 124 comprises the fifth and the sixth input side 126, 128 and the fifth output side 130. The third transmission unit 124, in particular the fifth and the sixth input side 126, 128, is on the input side connected to the drive 52. The drive 52 is connected to the sixth input side 128 and to the first variator 70 by way of the first transmission stage 80. The fifth input side 126 is connected to the fourth shifting element 800. The sixth input side 128 is connected to the fifth shifting element 802 by way of the first transmission stage 80. Presently, the first transmission stage 80 is designed as four engaged gearwheels with a freely rotating gearwheel.

The third transmission unit 124 is on the output side connectable to the first transmission unit 56, in particular to the first input side 72, in particular by the fourth or the fifth shifting element 800, 802 and by way of the first input shaft 132. Specifically, the drive 52 is connectable, or connected, to the fifth input side 126, and by way of the first transmission stage 80 to the sixth input side 128. The fifth output side 130 is connectable, or connected, to the first input side 72 by way of the first input shaft 132.

With the seventh embodiment according to FIG. 8, three modes per direction of rotation of the drive output 54 of the drive device 20, or in other words in the forward and reverse directions of the drive device 20 or working machine 10, can in each case be implemented with the first, the second and the third transmission unit 56, 58, 124 (see Table 4). Specifically, three forward and three reverse gears of the drive device 20 or working machine 10 can be implemented.

TABLE 4
Modes of the seventh embodiment.

| Forward | Reverse | | | | |
|---|---|---|---|---|---|
| Mode | Mode | 308 | 310 | 800 | 802 |
| Mode 1 | | | X | X | |
| Mode 2 | | X | | X | |
| Mode 3 | | X | X | | |
| | Mode 1 | | X | | X |
| | Mode 2 | X | | | X |
| | [symbol] | | X | | |

[symbol]

indicates data missing or illegible when filed

The modes can be implemented by opening and closing the shifting elements or coupling elements associated with the reference signs mentioned, as shown in Table 4. Specifically, the modes can be implemented by opening and closing the first shifting element 308 and/or the second shifting element 310 and/or the fourth shifting element 800 and/or the fifth shifting element 802 as illustrated in Table 4.

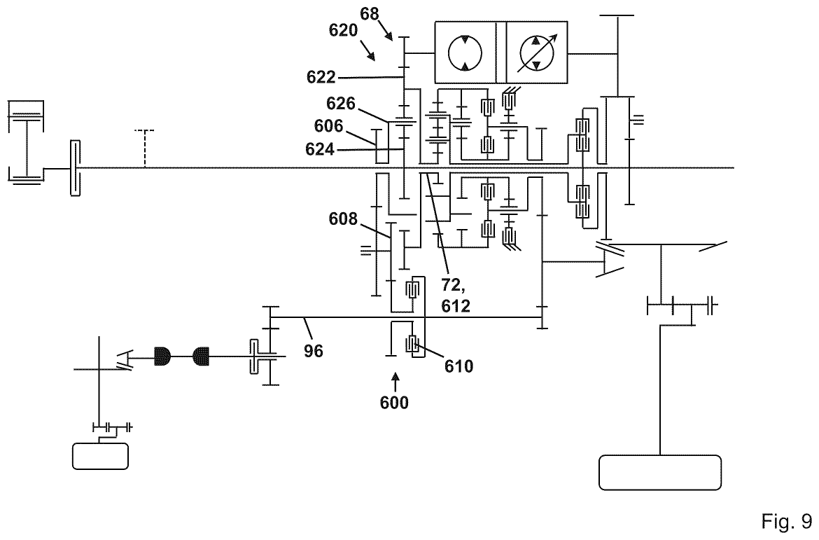

FIG. 9 shows a schematic illustration of the eighth example embodiment of the drive device 20 according to the disclosure. The drive device 20 shown in FIG. 9 corresponds substantially to the drive device 20 shown in FIGS. 1-8, and therefore only details and/or points of differentiation will be discussed below. The working machine 10 illustrated in FIG. 1 can comprise the drive device 20 illustrated in FIG. 9.

The drive device 20 comprises an alternative embodiment of the fourth transmission unit 600. The fourth transmission unit 600 comprises the third and the fourth spur gear stage 606, 608 and the fourth planetary transmission 620 and the sixth shifting element 610. The seventh input side 602 is the fourth ring gear 622 of the fourth planetary transmission 620. The fourth ring gear 622 is connected to the second variator 74 by way of the second transmission stage 68, wherein the second transmission stage 68 and the fourth ring gear 622 are engaged, in particular mesh with one another, or the fourth ring gear 622 is designed as a gearwheel or component of the second transmission stage 68. The fourth ring gear is connected, in particular as a seventh output side 630, to the second input side, in particular to the second input shaft 612. Moreover, the fourth sun 624 of the fourth planetary transmission 620 is connected to the drive 52. The fourth planet carrier 626 of the fourth planetary transmission 620 is connected to the third spur gear stage 606 by a further shaft. The third spur gear stage 606 is connected to the fourth spur gear stage 608 by a further shaft. The fourth spur gear stage 608 is connectable to the sixth shifting element 610 by way of a further shaft, and is connectable to the layshaft 96 by the sixth shifting element 610.

With the eighth embodiment according to FIG. 9, four modes per direction of rotation of the drive output 54 of the drive device 20, or in other words in the forward and reverse directions of the drive device 20 or working machine 10, can in each case be implemented by the first, the second, the third and the fourth transmission unit 56, 58, 124, 600 (see Table 5). Specifically, four forward and four reverse gears of the drive device 20 or working machine 10 can be implemented.

TABLE 6
Modes of the eighth embodiment

| Forward | Reverse | | | | | | |
|---|---|---|---|---|---|---|---|
| Mode | Mode | 308 | 310 | 616 | 610 | 800 | 802 |
| Mode 1 | | | | X | X | | |
| Mode 2 | | | X | X | | X | |
| Mode 3 | | X | | | | X | |
| Mode 4 | | | X | | | X | |
| | Mode 1 | | | X | X | | |
| | Mode 2 | | X | X | | | X |
| | Mode 3 | X | | | | | X |
| | Mode 4 | | X | | | | X |

The modes can be implemented by opening and closing the shifting elements or coupling elements associated with the reference signs mentioned, as shown in Table 5. Specifically, the modes can be implemented by opening and closing the first shifting element 308 and/or the second shifting element 310 and/or the third shifting element 616 and/or the fourth shifting element 800 and/or the fifth shifting element 802 and/or the sixth shifting element 610, as illustrated in Table 5.

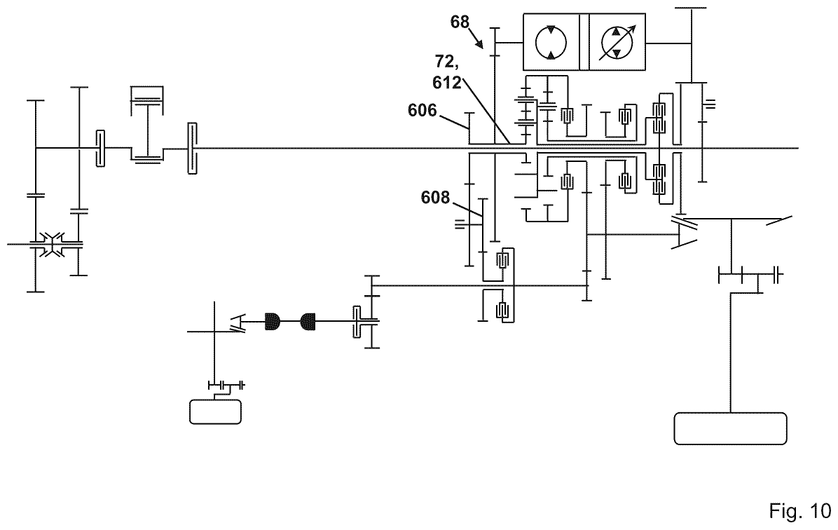

FIG. 10 shows a schematic illustration of the ninth example embodiment of the drive device 20 according to the disclosure. The drive device 20 shown in FIG. 10 corresponds substantially to the drive device 20 shown in FIGS. 1-9, and therefore only details and/or points of differentiation will be discussed below. The working machine 10 illustrated in FIG. 1 can comprise the drive device 20 illustrated in FIG. 10.

The second variator 74 is connected to the second input shaft 612 and thus to the second input side 72 by way of, or by, the second transmission stage 68, presently designed as a spur gear stage. The second input shaft 612 is moreover connected to the third spur gear stage 612. The third spur gear stage 606 is connected to the fourth spur gear stage 608 by way of a further shaft. A detailed schematic illustration and description of the second transmission unit 58 in FIG. 10 can be found in the context of FIG. 15.

With the ninth embodiment according to FIG. 10, three modes per direction of rotation of the drive output 54 of the drive device 20, or in other words in the forward and reverse directions of the drive device 20 or working machine 10, can be implemented in each case by the first, the second, the third and the fourth transmission unit 56, 58, 124, 600 (see Table 6). Specifically, three forward and three reverse gears of the drive device 20 or working machine 10 can be implemented.

Modes of the ninth embodiment

| Forward | Reverse | | | | | |
|---|---|---|---|---|---|---|
| Mode | Mode | 308 | 310 | 610 | 800 | 802 |
| Mode 1 | | | | X | | |
| Mode 2 | | | X | | X | |
| Mode 3 | | X | | | X | |
| | Mode 1 | | | X | | |
| | Mode 2 | | X | | | X |
| | [symbol] | [symbol] | | | | X |

[symbol]

indicates data missing or illegible when filed

The modes can be implemented by opening and closing the shifting elements or coupling elements associated with the reference signs mentioned, as shown in Table 6. Specifically, the modes can be implemented by opening and closing the first shifting element 308 and/or the second shifting element 310 and/or the fourth shifting element 800 and/or the fifth shifting element 802 and/or the sixth shifting element 610, as illustrated in Table 6.

FIG. 11 shows a detailed schematic illustration of an example embodiment of the first transmission unit 56 of the drive device 20 according to the disclosure. The first transmission unit 56 shown in FIG. 11 corresponds substantially to the first transmission unit 56 shown in FIGS. 1-10, and therefore only details and/or points of differentiation will be discussed below. The working machine 10 illustrated in FIGS. 1 and 20, or the drive device 20 illustrated in FIGS. 1-10, can comprise the first transmission unit 56 illustrated in FIG. 11.

The first transmission unit 58, in particular the planetary coupling transmission 300, comprises a first and/or a second planetary transmission 302, 304, wherein the planetary transmissions 302, 304 are coupled to one another. The first planetary transmission 302 comprises a double planet carrier 400. The double planet carrier 400 of the first planetary transmission 302 and the second planet carrier 402 of the second planetary transmission 304 are connected, in particular coupled, to one another. The double planet carrier 400 of the first planetary transmission 302 and the second planet carrier 402 of the second planetary transmission 304 form the first input side 72, or are connected to the latter. The drive 52 is connected to the double planet carrier 400 and to the second planet carrier 402, as a result of which a force and/or a torque and/or a rotating speed of the motor is able to be directed into the first transmission unit 56. Alternatively, the first input side 72 is connectable, or connected, to the fifth output side 130, in particular by way of the first input shaft 132, as a result of which a force and/or a torque and/or a rotating speed of the motor is able to be directed into the first transmission unit 56 by way of the third transmission unit 124. The second input side 78 is connected to the second input shaft 612. The second input side 72 is connected to the second variator 74. In other words, the second input shaft 612 can also be designed as the second input side 78. The second input shaft 612, or the second input side 78, is connected to a first sun gear 404 of the first planetary transmission 302. A first ring gear 406 of the first planetary transmission 302 and a second ring gear 408 of the second planetary transmission 304 are connected, in particular coupled, to one another. The first ring gear 406 of the first planetary transmission 302 and the second ring gear 408 of the second planetary transmission 304 form the first output side 82 or are connected to the latter. A second sun 410 of the second planetary transmission 304 forms the second output side 84, or is connected to the latter.

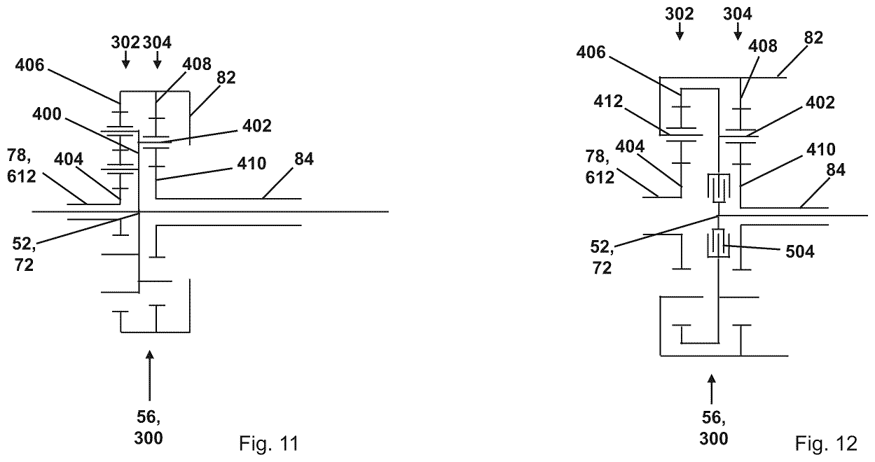

FIG. 12 shows a detailed schematic illustration of an example embodiment of the first transmission unit 56 of the drive device 20 according to the disclosure. The first transmission unit 56 shown in FIG. 12 corresponds substantially to the first transmission unit 56 shown in FIGS. 1-11, and therefore only details and/or points of differentiation will be discussed below. The working machine 10 illustrated in FIGS. 1 and 20, or the drive device 20 illustrated in FIGS. 1-11, can comprise the first transmission unit 56 illustrated in FIG. 12.

The first transmission unit 56, in particular the planetary coupling transmission 300, comprises the first and the second planetary transmission 302, 304, wherein the planetary transmissions 302, 304 are coupled to one another. The first ring gear 406 of the first planetary transmission 302 and the second planet carrier 402 of the second planetary transmission 304 are connected, in particular coupled, to one another. Moreover, the first planet carrier 412 of the first planetary transmission 302 and the second ring gear 408 of the second planetary transmission 304 are connected, in particular coupled, to one another. The first ring gear 406 of the first planetary transmission 302 and the second planet carrier 402 of the second planetary transmission 304 form the first input side 72 or are connected to the latter. The first sun 404 of the first planetary transmission 302 forms the second input side 78 or is connected to the latter. The first variator 70 is connectable to the input side 72 of the first transmission unit 56 by way of the drive 52 and the seventh shifting element 504, as a result of which a force and/or a torque and/or a rotating speed is able to be directed into the first transmission unit 56. Alternatively, the first input side 72 is connectable, or connected, to the fifth output side 130, in particular by way of the first input shaft 132, as a result of which a force and/or a torque and/or a rotating speed of the motor is able to be directed into the first transmission unit 56 by way of the third transmission unit 124. The second variator 74 is connected to the second input side 78, in particular by way of a, or by the, second transmission stage 68. The second input side 78 is connected to the second input shaft 612. In other words, the second input shaft 612 can also be designed as the second input side 78. The second input shaft 612, or the second input side 78, is connected to the first sun gear 404 of the first planetary transmission 302. The first planet carrier 412 of the first planetary transmission 302 and the second ring gear 408 of the second planetary transmission 304 form the first output side 82 or are connected to the latter. A second sun 410 of the second planetary transmission 304 forms the second output side 84 or is connected to the latter.

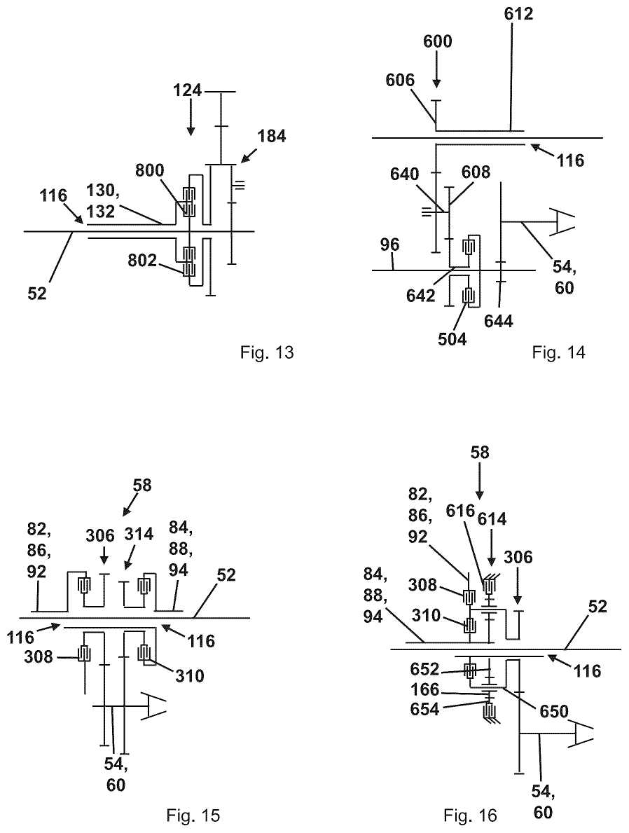

FIG. 13 shows a detailed schematic illustration of an example embodiment of the third transmission unit 124 of the drive device 20 according to the disclosure. The third transmission unit 124 shown in FIG. 13 corresponds substantially to the third transmission unit 124 shown in FIGS. 1 to 12, and therefore only details and/or points of differentiation will be discussed below. The working machine 10 illustrated in FIGS. 1 and 20, or the drive device 20 illustrated in FIGS. 1 to 12, can comprise the third transmission unit 124 illustrated in FIG. 13.

The third transmission unit 124 can in particular be a reversing unit or a powershift reversing unit. The third transmission unit 124 can be designed to reverse the direction of travel. Thus, a direction of rotation of the drive 52 can be reversible by the third transmission unit 124. The third transmission unit 124 is on the input side connected to the drive 52. The third transmission unit 124 is on the output side connectable, or connected, to the first transmission unit 56, in particular to the first input side 72, in particular by way of the fifth output side 130, by way of a first input shaft 132. In this example embodiment, the third transmission unit 124 comprises the fourth and the fifth shifting element 800, 802 and optionally the first transmission stage 80. The fifth shifting element 800 is connectable, or connected, to the drive 52. The fifth shifting element 802 is connectable, or connected, to the drive 52 by way of the, or by the, first transmission stage 80. The fourth or the fifth shifting element 800, 802 is connectable, or connected, to the first input shaft 132. Alternatively, the third transmission unit 124 can be embodied in a planetary construction mode. The third transmission unit 124 moreover has conduits 116, in particular central conduits, for the drive 52.

FIG. 14 shows a detailed schematic illustration of an example embodiment of the fourth transmission unit 600 of the drive device 20 according to the disclosure. The fourth transmission unit 600 shown in FIG. 14 corresponds substantially to the fourth transmission unit 600 shown in FIGS. 1-13, and therefore only details and/or points of differentiation will be discussed below. The working machine 10 illustrated in FIGS. 1 and 20, or the drive device 20 illustrated in FIGS. 1 to 13, can comprise the fourth transmission unit 600 illustrated in FIG. 14.

The fourth transmission unit 600 can in particular be designed as a start-up unit. The fourth transmission unit 600 is on the input side connectable, or connected, to the first transmission unit 56 by way of the, or by the, second input shaft 612. The fourth transmission unit 600 is on the output side connectable, or connected, to the layshaft 96. The fourth transmission unit 600 comprises the third spur gear stage 606 and a fourth spur gear stage 608 and a seventh shifting element 196. The third spur gear stage 606 is connected to the fourth spur gear stage 608. The third spur gear stage 606 is connected to the fourth spur gear stage 608 by way of a shaft 640 which can in particular be idling. The fourth spur gear stage 608 is connected to the seventh shifting element 504, in particular by way of a further shaft 642. The fourth spur gear stage 608 is connectable to the layshaft 96 with the seventh, or by the seventh, shifting element 504. Furthermore, the layshaft 96 is connected to the drive output 54, in particular to the drive output shaft 60, by way of the, or by the, coupling gearwheel 644. The fourth transmission unit 600 moreover has conduits 116, in particular central conduits, for the drive 52.

FIG. 15 shows a detailed schematic illustration of a further example embodiment of the second transmission unit 58 of the drive device 20 according to the disclosure. The second transmission unit 58 shown in FIG. 15 corresponds substantially to the second transmission unit 58 shown in FIGS. 1 to 14, and therefore only details and/or points of differentiation will be discussed below. The working machine 10 illustrated in FIGS. 1 and 20, or the drive device 20 illustrated in FIGS. 1-13, can comprise the second transmission unit 58 illustrated in FIG. 15.

In an alternative or further embodiment, the second transmission unit 58 comprises the first and the second spur gear stage 306, 314 and the first and the second shifting element 308, 310 (see also FIG. 10). The first shifting element 308 here is connected to the first output side 82 and to the third input side 86, in particular to the third input shaft 92. The second shifting element 310 is connected to the second output side 84 and to the fourth input side 88, in particular to the fourth input shaft 94. The first shifting element 308 is connectable, or connected, to the first spur gear stage 306, and the fourth shifting element 310 is connectable, or connected, to the second spur gear stage 314. The first output side 82 and/or the third input side 86 can be connectable, or connected, to the first spur gear stage 306 by the, or by way of the, first shifting element 308, and/or the second output side 84 and/or the fourth input side 88 can be connectable, or connected, to the second spur gear stage 314 by the, or by way of the, second shifting element 310. The first and the second spur gear stage 306, 314 are connected to the drive output 54, in particular the drive output shaft 60. The second transmission unit 58 moreover has conduits 116, in particular central conduits, for the drive 52.

FIG. 16 shows a detailed schematic illustration of a further example embodiment of the second transmission unit 58 of the drive device 20 according to the disclosure. The second transmission unit 58 shown in FIG. 16 corresponds substantially to the second transmission unit 58 shown in FIGS. 1-15, and therefore only details and/or points of differentiation will be discussed below. The working machine 10 illustrated in FIGS. 1 and 20, or the drive device 20 illustrated in FIGS. 1-14, can comprise the second transmission unit 58 illustrated in FIG. 16.

The second transmission unit 58 comprises the third planetary transmission 614 and the first spur gear stage 306 and the first and the second shifting element 308, 310. The first shifting element 308 here is connected to the first output side 82 and to the third input side 86, in particular to the third input shaft 92. Moreover, the third input shaft 92 is connectable to a third planet carrier 650 of the third planetary transmission 614 by the first shifting element 308. The fourth input shaft 94 is connected to the third sun 652 of the third planetary transmission 614. The third shifting element 616, which is designed as a brake, is connected to the first ring gear 654 of the third planetary transmission 614. Moreover, the third planet carrier 650 of the third planetary transmission 614 is connected to the first spur gear stage 306. The first spur gear stage 306 is connected to the drive output 54, in particular the drive output shaft 60. The second transmission unit 58 moreover has conduits 116, in particular central conduits, for the drive 52.

FIG. 17 shows a schematic illustration of a first example embodiment of a transmission housing assembly 900 according to the disclosure. The transmission housing assembly 900 shown in FIG. 17 can comprise the drive device 20 shown in FIGS. 1-16, or components of the drive device 20 according to the disclosure, and therefore only details and/or points of differentiation will be discussed below. The working machine 10 illustrated in FIGS. 1 and 20 can comprise the transmission housing assembly 900 illustrated in FIG. 17.

The transmission housing assembly 900 comprises a first housing module 902 with the first transmission unit 56. Specifically, the first transmission unit 56 is disposed in the first housing module 902. The transmission housing assembly 900 comprises a second housing module 904 with the second transmission unit 58. Specifically, the second transmission unit 58 is disposed in the second housing module 904.

Additionally, the transmission housing assembly 900 can comprise a third housing module 906 with the third transmission unit 124. Specifically, the third transmission unit 124 can be disposed in the third housing module 906. Additionally, the transmission housing assembly 900 can comprise a fourth housing module 908 with the fourth transmission unit 600. Specifically, the fourth transmission unit 600 can be disposed in the fourth housing module 908. The first and the second and the third and the fourth housing module 902, 904, 906, 908 are disposed along or in the direction of the drive 52, in particular of the drive shaft 50. The housing modules are disposed successively and adjacent in the sequence of fourth and first and second and third housing module 908, 902, 904, 906. Additionally, the drive 52 and/or the layshaft 96 and/or the second transmission stage 74 and/or the second variator 74 and/or the first and/or the second and/or the third and/or the fourth input shaft 132, 612, 92, 94 can be disposed in the first housing module 902. Additionally, the drive 52 and/or the layshaft 96 and/or the drive output 54, in particular the drive output shaft 60, and/or the first and/or the third and/or the fourth input shaft 132, 92, 94 can be disposed in the second housing module 904. Additionally, the drive 52 and/or the layshaft 96 and/or the drive output 54, in particular the drive output shaft 60, and/or the first and/or the third and/or the fourth input shaft 132, 92, 94 can be disposed in the third housing module 906. Additionally, the drive 52 and/or the layshaft 96 and/or the first and/or the second input shaft 132, 612 can be disposed in the fourth housing module 908.

The fourth housing module 908 has an input-side housing wall 920. The fourth housing module 908 has an output-side housing wall 950. The input-side housing wall 920 of the fourth housing module 908 has a sixth input opening 910. The sixth input opening 910 can be designed for feeding through and/or for linking and/or connecting the drive 52, in particular the drive shaft 50. The drive 52, in particular the drive shaft 50, is disposed in the sixth input opening 910 of the input-side housing wall 920 of the fourth housing module 908. Specifically, the drive 52, in particular the drive shaft 54, extends through the sixth input opening 910.

Additionally, the input-side housing wall 920 can have a seventh input opening 912. The seventh input opening 912 can be designed for feeding through and/or for linking and/or connecting the layshaft 96. The layshaft 96 can be disposed in the seventh input opening 912 of the input-side housing wall 920. Specifically, the layshaft 96 can extend through the seventh input opening 912. The output-side housing wall 950 of the fourth housing module 908 comprises an eighth output opening 952. The eighth output opening 952 is designed for feeding through and/or for linking and/or connecting the drive 52, in particular the drive shaft 50. Additionally, the eighth output opening 952 can be designed for feeding through and/or for linking and/or connecting the second input shaft 612. The drive 52, in particular the drive shaft 50, and/or the second input shaft 612 is disposed in the eighth output opening 952. Specifically, the drive 52, in particular the drive shaft 50, and/or the second input shaft 612 extends through the eighth output opening 952. Additionally, the output-side housing wall 950 can have a ninth output opening 954. The ninth output opening 954 can be designed for feeding through and/or for linking and/or connecting the layshaft 96. The layshaft 96 can be disposed in the ninth output opening 954. Specifically, the layshaft 96 can extend through the ninth output opening 954.

The first housing module 902 has an input-side housing wall 956. The fourth housing module 908 comprises an output-side housing wall 960. The input-side housing wall 956 comprises a first input opening 958. The first input opening 958 is designed for feeding through and/or for linking and/or connecting the drive 52, in particular the drive shaft 50, and/or the second input shaft 612. The drive 52, in particular the drive shaft 50, and the second input shaft 612 are disposed in the first input opening 958. Specifically, the drive 52, in particular the drive shaft 50, and the second input shaft 612 extend through the first input opening 958. Additionally, the input-side housing wall 956 of the first housing module 902 can have a second input opening 962. The second input opening 962 can be designed for feeding through and/or for linking and/or connecting the layshaft 96. The layshaft 96 can be disposed in the second input opening 962 of the input-side housing wall 956. Specifically, the layshaft 96 can extend through the second input opening 962.

The output-side housing wall 960 of the first housing module 902 comprises a first output opening 964. The first output opening 964 is designed for feeding through and/or for linking and/or connecting the drive 52. Additionally, the first output opening 964 can be designed for feeding through and/or for linking and/or connecting the first and/or the third and/or the fourth input shaft 132, 92, 94. The drive 52, in particular the drive shaft 50, and/or the first and/or the third and/or the fourth input shaft 132, 92, 94 is disposed in the first output opening 964. Specifically, the drive 52, in particular the drive shaft 50, and/or the first and/or the third and/or the fourth input shaft 132, 92, 94 extends through the first output opening 964. Additionally, the output-side housing wall 960 can comprise a third output opening 966. The third output opening 966 can be designed for feeding through and/or for linking and/or connecting the layshaft 96. The layshaft 96 can be disposed in the third output opening 966. Specifically, the layshaft 96 can extend through the third output opening 966.

The second housing module 904 has an input-side housing wall 968. The second housing module 904 has an output-side housing wall 970. The input-side housing wall 968 of the second housing module 904 comprises a third input opening 972. The third input opening 972 is designed for feeding through and/or for linking and/or connecting the drive 52, in particular the drive shaft 50. Additionally, the third input opening 972 can be designed for feeding through and/or for linking and/or connecting the first and/or the third and/or the fourth input shaft 132, 92, 94. The drive 52, in particular the drive shaft 50, and/or the first and/or the third and/or the fourth input shaft 132, 92, 94 is disposed in the third input opening 972. Specifically, the drive 52, in particular the drive shaft 50, and/or the first and/or the third and/or the fourth input shaft 132, 92, 94 extend through the third input opening 972. Additionally, the input-side housing wall 968 of the second housing module 904 can have a fourth input opening 974. The fourth input opening 974 can be designed for feeding through and/or for linking and/or connecting the layshaft 96. The layshaft 96 can be disposed in the fourth input opening 974 of the input-side housing wall 968. Specifically, the layshaft 96 can extend through the fourth input opening 974.

The output-side housing wall 970 of the second housing module 904 comprises a fourth output opening 974. The fourth output opening 974 is designed for feeding through the drive 52. Additionally, the fourth output opening 974 can be designed for linking and/or connecting the first input shaft 132. The drive 52, in particular the drive shaft 50, and/or the first input shaft 132 is disposed in the fourth output opening 974. Specifically, the drive 52, in particular the drive shaft 50, and/or the first input shaft 132 extends through the fifth output opening 974.

Additionally, the output-side housing wall 970 can have a fifth output opening 976. The fifth output opening 976 can be designed for feeding through and/or for linking and/or connecting the drive output 54. The drive output 54, in particular the drive output shaft 60, can be disposed in the fifth output opening 976. Specifically, the drive output 54, in particular the drive output shaft 60, can extend through the fifth output opening 976. The third housing module 906 has an input-side housing wall 978. The third housing module 906 has an output-side housing wall 982.

The input-side housing wall 978 of the third housing module 906 comprises a fifth input opening 980. The fifth input opening 980 is designed for feeding through and/or for linking and/or connecting the drive 52, in particular the drive shaft 50. The fifth input opening 980 can be designed for feeding through and/or for linking and/or connecting the first input shaft 132. The drive 52, in particular the drive shaft 50, and/or the first input shaft 132 is disposed in the fifth input opening 980. Specifically, the drive 52, in particular the drive shaft 50, and/or the first input shaft 132 extend through the fifth input opening 980. Additionally, the output-side housing wall 982 of the third housing module 906 can have a sixth output opening 984. The sixth output opening 984 is designed for feeding through and/or for linking and/or connecting the drive 52, in particular the drive shaft 50, to the first power output 46. The drive 52, in particular the drive shaft 50, is disposed in the sixth output opening 984. Specifically, the drive 52, in particular the drive shaft 50, extends through the sixth output opening 984.

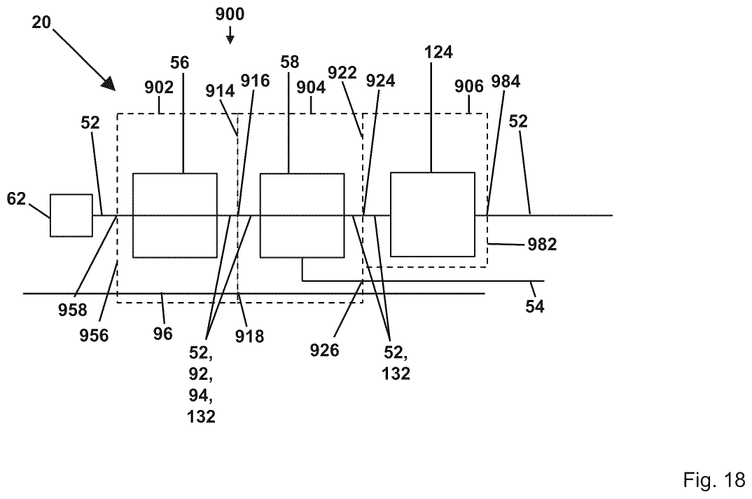

FIG. 18 shows a schematic illustration of a second example embodiment of a transmission housing assembly 900 according to the disclosure. The transmission housing assembly 900 shown in FIG. 18 can comprise the drive device 20 shown in FIGS. 1-17, or components of the drive device 20 according to the disclosure, and therefore only details and/or points of differentiation will be discussed below. The transmission housing assembly 900 shown in FIG. 18 corresponds substantially to the transmission housing assembly 900 shown in FIG. 17, and therefore only details and/or points of differentiation will be discussed below. The working machine 10 illustrated in FIGS. 1 and 20 can comprise the transmission housing assembly 900 illustrated in FIG. 18.

The first and the second and the third housing module 902, 904, 906 are disposed along or in the direction of the drive 52, in particular of the drive shaft 50. The housing modules are disposed successively and directly adjacent in the sequence of first and second and third housing module 902, 904, 906.

Alternatively, the output-side housing wall 960 of the first housing module 902 and the input-side housing wall 968 of the second housing module 904 are designed as the first common housing wall 914 of the first and the second housing module 902, 908. The first common housing wall 914 has a first conduit opening 916. The first common housing wall 914 can have a second conduit opening 918. The first conduit opening 916 is designed for feeding through and/or for linking and/or connecting the drive 52, in particular the drive shaft 50, and/or the first and/or the third and/or the fourth input shaft 132, 92, 94. The second conduit opening 918 can be designed for feeding through and/or for linking and/or connecting the second input shaft 612. The drive 52, in particular the drive shaft 50, and/or the first and/or the third and/or the fourth input shaft 132, 92, 94 is disposed in the first conduit opening 916. Specifically, the drive 52, in particular the drive shaft 50, and/or the first and/or the third and/or the fourth input shaft 132, 92, 94 extend through the first conduit opening 912. The layshaft 106 can be disposed in the second conduit opening 918. Specifically, the layshaft 106 can extend through the second conduit opening 918.

Alternatively, the output-side housing wall 970 of the second housing module 904 and the input-side housing wall 978 of the third housing module 906 are designed as the second common housing wall 922 of the second and the third housing module 904, 906. The second common housing wall 922 has a third conduit opening 924. The third conduit opening 924 is designed for feeding through and/or for linking and/or connecting the drive 52, in particular the drive shaft 50, and/or the first input shaft 132. The drive 52, in particular the drive shaft 50, and/or the first input shaft 132 can be disposed in the third conduit opening 924. Specifically, the drive 52, in particular the drive shaft 50, and/or the first input shaft 132 extend through the third conduit opening 924.

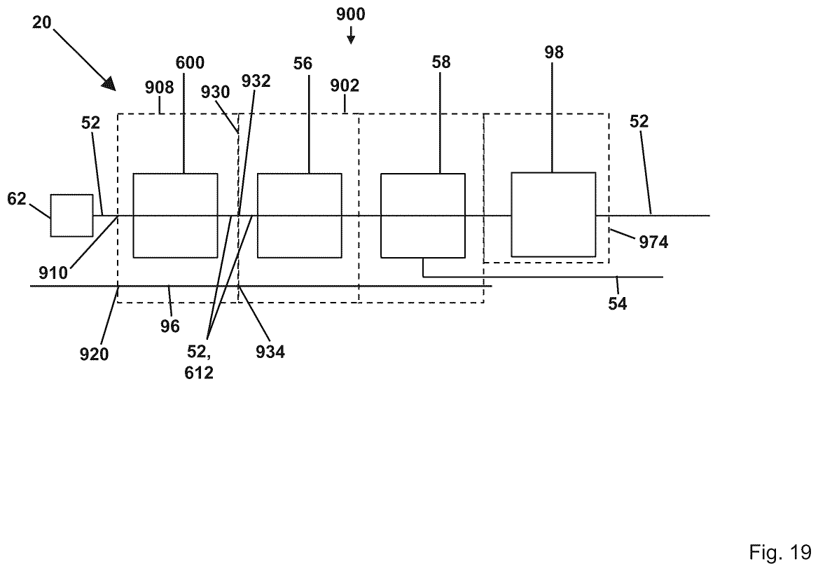

FIG. 19 shows a schematic illustration of a third example embodiment of a transmission housing assembly 900 according to the disclosure. The transmission housing assembly 900 shown in FIG. 19 can comprise the drive device 20 shown in FIGS. 1-18, or components of the drive device 20 according to the disclosure, and therefore only details and/or points of differentiation will be discussed below. The transmission housing assembly 900 shown in FIG. 19 corresponds substantially to the transmission housing assembly 900 shown in FIGS. 17 and 18, and therefore only details and/or points of differentiation will be discussed below. The working machine 10 illustrated in FIGS. 1 and 20 can comprise the transmission housing assembly 900 illustrated in FIG. 19.

The first and the second and the third and the fourth housing module 902, 904, 906, 908 are disposed along or in the direction of the drive 52, in particular of the drive shaft 50. The housing modules are disposed successively and directly adjacent in the sequence of fourth and first and second and third housing module 908, 902, 904, 906.

The output-side housing wall 950 of the fourth housing module 908 and the input-side housing wall 956 of the first housing module 902 are formed as the third common housing wall 930 of the first and the fourth housing module 902, 908. The first common housing wall 930 can have a fourth conduit opening 932. The first common housing wall 930 can have a fifth conduit opening 934. The drive 52, in particular the drive shaft 50, and/or the second input shaft 612 are disposed in the fourth conduit opening 932. Specifically, the drive 52, in particular the drive shaft 50, and/or the second input shaft 612 extend through the fourth conduit opening 932. The layshaft 106 can be disposed in the fifth conduit opening 934. Specifically, the layshaft 106 can extend through the fifth conduit opening 934.

As a result, the housing assembly can advantageously be able to be easily linked and/or be of modular construction.

FIG. 20 shows a detailed schematic illustration of a further example embodiment of the working machine 10 according to the disclosure, having a transmission housing assembly 900 according to the disclosure. The transmission housing assembly 900 shown in FIG. 20 can comprise the drive device 20 shown in FIGS. 1-19, or components of the drive device 20 according to the disclosure, and therefore only details and/or points of differentiation will be discussed below. The transmission housing assembly 900 shown in FIG. 20 corresponds substantially to the transmission housing assembly 900 shown in FIGS. 17 to 19, and therefore only details and/or points of differentiation will be discussed below. The working machine 10 illustrated in FIG. 1 can comprise the transmission housing assembly 900 illustrated in FIG. 20.

FIG. 20 schematically shows two frame elements 990, in particular a first and a second frame element 992, 994, of the working machine 10. The transmission housing assembly 900, in particular the first and the second and the third and the fourth housing module 902, 904, 906, 908, are disposed at, in particular between, the two frame elements 990, in particular the first and the second frame element 992, 994. The frame elements 990, 992, 994 can be disposed at, in particular between or directly adjacent to, the first and the second differential 30, 32. The motor 62 can be disposed at, in particular on or between the two frame elements 990, in particular the first and the second frame element 992, 994. The transmission housing assembly 900, in particular the first and the second and the third and the fourth housing module 902, 904, 906, 908, are disposed along a longitudinal axis 996 of the working machine 10. The drive 52, in particular the drive shaft 50, and the longitudinal axis 996 of the working machine 10 can be identical or parallel.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A drive device for a working machine or a transmission housing assembly, comprising:
a drive,
a drive output,
a first and a second variator, and
a first transmission unit configured as a planetary coupling transmission having a first and a second input sides and a first and a second output sides,
wherein the first variator is connectable, or connected, to the drive, the second variator is connected to the second input side, and the drive device comprises a second transmission unit having a third and a fourth input sides and at least one third output side,
wherein the first output side is connectable to the third input side or the second output side is connectable to the fourth input side, and the third output side of the second transmission unit is connectable to the drive output.

2. The drive device of claim 1, wherein the planetary coupling transmission of the first transmission unit has two different stationary transmission ratios.

3. The drive device of claim 1, wherein the second transmission unit comprises at least one of a first spur gear stage, a second spur gear stage, or a third planetary transmission, and at least a first and a second shifting elements.

4. The drive device of claim 1, comprising a third transmission unit having a fifth input side, a sixth input side, and a fifth output side, and the third transmission unit is connectable to the drive and to the first transmission unit.

5. The drive device of claim 1, further comprising a fourth transmission unit having at least one seventh input side and at least one sixth output side, wherein the fourth transmission unit is connectable to the first transmission unit or is connectable to a layshaft.

6. The drive device of claim 1, wherein the first variator, via the drive and a seventh shifting element, is connectable to the first input side.

7. The drive device of claim 1, wherein the first variator is configured as a first electric motor, and the second variator is configured as a second electric motor, or the first and the second variators are configured a hydrostat.

8. The drive device of claim 1, further comprising a motor, via the drive, connected to the first input side and to the first variator.

9. The drive device of claim 1, further comprising a motor, via the drive, connected to the fifth and the sixth input side and to the first variator.

10. The drive device of claim 1, wherein the first, the second, the third, or the fourth transmission unit has a conduit for the drive.

11. The drive device of claim 1, wherein the motor or the first variator is connectable, or connected, to a first power output.

12. The drive device of claim 1, wherein the first output side is connectable to the third input side, and the second output side is connectable to the fourth input side.

13. A transmission housing assembly, comprising:
a drive device including:
a drive,
a drive output,
a first and a second variator, and
a first transmission unit configured as a planetary coupling transmission having a first and a second input sides and a first and a second output sides, and
a first housing module with the first transmission unit, and a second housing module with the second transmission unit, and the first and the second housing modules are disposed along the drive,
wherein the first variator is connectable, or connected, to the drive, the second variator is connected to the second input side, and the drive device comprises a second transmission unit having a third and a fourth input sides and at least one third output side,
wherein the first output side is connectable to the third input side or the second output side is connectable to the fourth input side, and the third output side of the second transmission unit is connectable to the drive output.

14. The transmission housing assembly of claim 13, further comprising a third housing module with the third transmission unit, wherein the first, the second, and the third housing modules are disposed along the drive.

15. The transmission housing assembly of claim 13, further comprising a fourth housing module with the fourth transmission unit, wherein the first, the second, the third, and the fourth housing modules are disposed along the drive.

16. A working machine comprising:
a transmission housing assembly, comprising:
a drive device including:
a drive,
a drive output,
a first and a second variator, and
a first transmission unit configured as a planetary coupling transmission having a first and a second input sides and a first and a second output sides, and
a first housing module with the first transmission unit, and a second housing module with the second transmission unit, and the first and the second housing modules are disposed along the drive,
wherein the first variator is connectable, or connected, to the drive, the second variator is connected to the second input side, and the drive device comprises a second transmission unit having a third and a fourth input sides and at least one third output side,
wherein the first output side is connectable to the third input side or the second output side is connectable to the fourth input side, and the third output side of the second transmission unit is connectable to the drive output.

17. The working machine of claim 16, comprising two frame elements, wherein the drive device or the transmission housing assembly is at least partially disposed on the frame elements.
